(19) United States
(12) Patent Application Publication
(10) Pub. No.: US 2006/0121933 A1
(43) Pub. Date: Jun. 8, 2006

(54) Electronic device, signal transmission device, and radio communication terminal

(75) Inventor: Masayuki Ikeda, Shiojiri (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/291,143

(22) Filed: Nov. 30, 2005

(30) Foreign Application Priority Data
Dec. 7, 2004 (JP) 2004-353663

(51) Int. Cl. H04B 1/38; H04M 1/00

(52) U.S. Cl. 455/550.1; 455/90.3

(57) ABSTRACT

An electronic device includes: a generator that generates transmission data in a form of a serial signal; an oscillator that generates a carrier wave; a modulator that modulates the carrier wave with the signal from the generator; a line transmission channel that transmits a signal modulated in the modulator; a demodulator that receives and demodulates the signal transmitted via the line transmission channel; a receiver that receives the transmission data according to a demodulated signal demodulated in the demodulator; and a common housing that accommodates at least the modulator and the demodulator.

### BACKGROUND

1. Technical Field

The present invention relates to an electronic device, a signal transmission device, and a radio communication terminal each incorporating an element that needs high-speed data transfer, such as a display element and an imaging sensor.

2. Related Art

Improvements of functions in recent years with a cellular phone, a notebook computer, and a digital camera are remarkable. The need for a display element and an imaging sensor incorporated into such an electronic device to achieve higher resolution and higher definition has been increasing, and the circuit configuration or the like is increasing the complexity. In particular, a cellular phone is now furnished with a camera function and provided with a larger, high-functional display portion. On the other hand, the need for a reduction in size and weight and a saving in power consumption has been increasing. In addition, the mainstream of the housing structure is a folding type called a clamshell type or a flip type.

FIG. 14 is a block diagram showing a typical configuration of an electronic device using an active-matrix liquid crystal display body as a display element. FIGS. 15A through 15K are time charts of the electronic device.

As is shown in FIG. 14, a CPU 1301 generates image data to be displayed by expanding or computing a compressed image or moving image data in the JPEG format or the MPEG format. Having generated the image data to be displayed, the CPU 1301 writes the image data into a video memory 1302. A liquid crystal controller 1303 generates various timings needed for liquid crystal display, that is, an X clock signal 1315 and a horizontal synchronizing signal 1314 for an X driver 1313, and a vertical synchronizing signal 1318 for a Y shift register 1307. It also reads out the image data from the video memory 1302 according to the display sequence, and sends the image data to the drivers (the X driver 1313 and the Y shift register 1307) of the liquid crystal display body 1308. In a case where the liquid crystal display body 1308 comprises n rows and m columns of pixels, the X driver 1313 comprises an m-stage X shift register 1304, an m-word latch 1305, and m DA converter circuits 1306.

The liquid crystal controller 1303 generates a vertical synchronizing signal 1318 when it reads out a pixel at the top of the display frame, and sends the vertical synchronization signal 1318 to the Y shift register 1307. Simultaneously, the liquid crystal controller 1303 reads out data to be displayed by the pixel in the first row and the first column of the liquid crystal display body 1308 from the video memory 1302, and sends the data to the data terminal of the latch 1305 as a display data signal 1316.

As is shown in FIGS. 15A through 15K, the X shift register 1304 reads in a horizontal synchronizing signal 1314 generated in the liquid crystal controller 1303 in sync with an X clock signal 1315, and generates a signal X1 latch (FIG. 15C) to latch the image data for the first column. The data to be displayed by the pixel in the first row and the first column is latched in the first column of the latch 1305 by the signal X1 latch. Subsequently, the liquid crystal controller 1303 reads out data to be displayed by the following pixel from the video memory 1302, and outputs the data to the data terminal of the latch 1305. When the data to be displayed by the following pixel is outputted to the data terminal of the latch 1305, the X shift register 1304 in the X driver 1313 shifts the horizontal synchronizing signal 1314 by one stage, and generates a signal X2 latch (FIG. 15D) to latch the image data for the second column for the latch 1305 to latch the image data for the first row and the second column.

Thereafter, the X shift register 1304 shifts the horizontal synchronizing signal 1314 one by one for the latch 1305 to latch the data to be displayed in the first row. When the latch 1305 has stored one row of data, a next horizontal synchronizing signal 1314 (FIG. 15A and FIG. 15H; it should be noted that time scales along the abscissa are different between FIGS. 15A through 15F and FIGS. 15G through 15K, and the same horizontal synchronizing signal is shown in FIG. 15H in addition to FIG. 15A) is outputted. The DA converter circuit 1306 then subjects the data held in the latch 1305 to DA conversion, and outputs the resultant analog signal to an i'th (1≦i≦m) column electrode 1310. Simultaneously, the Y shift register 1307 outputs a selection signal Y1 to the row electrode 1309 in the first row.

Thereafter, the Y shift register (Y driver) 1307 shifts a selection signal Yj outputted to a j'th (1≦j≦n) row electrode 1309 one by one in the same manner as above each time the horizontal synchronizing 1314 is outputted.

An enlarged view of one pixel portion arrayed in a matrix fashion on the liquid crystal display body 1308 is shown inside of a circle indicated by an alternate long and short dash line in FIG. 14. When a j'th row electrode 1309 is selected, an active switch element 1311 transmits an output of the DA converter circuit 1306 outputted to an i'th column electrode 1310 to a pixel electrode 1312 in a j'th row and an i'th column. Only one DA converter circuit 1306 may be disposed on the liquid crystal controller 1303 side, so that the display data signal 1316 is transmitted in the form of an analog signal. In this case, the latch 1305 serves as an analog sample and hold circuit. This method is used in many cases in the related art because the number of the DA converter circuits 1306 can be reduced. However, because it is sufficient that an average value of a voltage finally applied to the pixel electrodes 1312 is a specific value, a digital circuit can be used for pulse width modulation, and an analog sample and hold circuit can be omitted. Hence, the method using the DA converter circuits 1306 as above is now becoming the mainstream as the density of an LSI increases.

It should be noted, however, that the display data signal 1316 is transmitted in the form of a digital signal in this method, and a large number of signal lines are necessary. For example, 8 bits×3 primary colors, that is, 24 signal lines in total are necessary to transmit the display data signal 1316.

A period since a display data signal 1316 at the right end of the row on the screen is outputted from the liquid crystal controller 1303 until a display data signal 1316 at the left end of the following row is outputted, or since a display data signal 1316 for the last row on the screen is outputted until a display data signal 1316 for the first row of the following frame is outputted, is referred to as a (horizontal, vertical) blanking period or a fly-back period. Because this period cannot be reduced to 0 (nil) with the CRT because an electronic beam reciprocates. However, it can be reduced to 0 (nil) with the liquid crystal display body 1308 because the pixel electrode 1312 is selected through the switching operation of the active switch element 1311. A horizontal fly-back period for one pixel and a vertical fly-back period for one row are shown in FIGS. 15A through 15K by way of example.

In an electronic device using an imaging sensor, such as a digital camera, the same circuit configuration is used except that a signal is transmitted in a direction opposite to the direction when the liquid crystal display body 1308 is used.

For an electronic device incorporating such a display body element or an imaging sensor, there have been needs for a larger display, higher resolution, and a reduction in size and weight. For this reason, more than one mount board is used to mount the electronic device shown in FIG. 14 in many cases. In such a case, the mount board is often partitioned along an alternate long and short dash line 1317-1317′ in FIG. 14.

A line linking the CPU 1301 and the liquid crystal display body 1308 is naturally extended. When an imaging sensor is incorporated into the configuration of FIG. 14, because the same circuit configuration is used except that a signal is transmitted in a direction opposite to the direction when the liquid crystal display body 1308 is used, a line linking the CPU 1301 and the imaging sensor is extended in this case, too.

As has been described, a large number of parallel signal lines are necessary to transmit the display data signal 1316 from the liquid crystal controller 1303 to the liquid crystal display body 1308. Signal lines may be reduced by applying parallel-serial to serial-parallel conversion, so that data is transmitted in the form of a serial signal. However, only a small volume of data can be transmitted via a single transmission channel by the technique in the related art. A volume of data has already exceeded a transmission capacity of a single transmission channel by satisfying the need for high-speed transmission arising from an increase in complexity of the equipment in recent years. It is therefore quite difficult to reduce the number of transmission channels through the serializing of data by the technique in the related art. Under these circumstances, there is no choice but to transmit data in parallel via a large number of lines. In other words, as the resolution of the liquid crystal display body 1308 and the imaging sensor becomes higher, frequencies of signals transmitted via these lines become higher. This makes it difficult to establish a connection with the CPU 1301 and the liquid crystal controller 1303. In particular, the clamshell structure is a structure in which two substrates are connected via a narrow hinge portion. Hence, as the resolution of the display element and the imaging sensor becomes higher, a larger volume of data is transmitted between the two substrates when the mount substrate is partitioned along the alternate long and short dash line 1317-1317′ in FIG. 14. However, it is extremely difficult to pass plural transmission channels through a narrow hinge portion using a large number of lines. To overcome this problem, a method is proposed, by which data to be transmitted is serialized, so that the data can be transmitted at a high speed via fewer transmission lines. As a high-speed data transmission scheme, it is proposed to use, for example, LVDS (Low Voltage Differential Signaling), to establish a connection with the display body or the imaging sensor as is disclosed in Japanese Patent No. 3086456 (paragraph 44) and Japanese Patent No. 3330359 (paragraph 46). Japanese Patent Nos. 3349426 and 3349490, however, propose a new method on the ground that the technique disclosed in the first two documents is insufficient.

These techniques in the related art, however, relate to transmission of a digital baseband signal, and sufficient transmission power is required at the transmitting end to ensure a logic level at the data receiving end. This raises a problem that interference with the surroundings occurs due to power consumption and unwanted emission. In addition, a digital baseband signal has several times as many frequency components as the transmission rate from the DC, and its frictional band is extremely large.

In other words, in order to ensure the logic level at the receiving end, large signal power is required from the start. Moreover, a well-matched impedance terminal is necessary to transmit a signal at good accuracy. However, because the transmission impedance is about 100 ohms at most, power consumed at the terminating resistor becomes unacceptably large. Further, because the frictional band of a signal to be transmitted is extremely large, the impedance of the transmission channel is not stabilized within the band. Moreover, the frequency characteristic varies with the mounting state and the routing of wires, which makes it difficult to achieve correct impedance matching. In particular, it is difficult to match the characteristic of the transmitter and receiver circuits incorporated into a semiconductor integrated circuit to the transmission impedance that varies from circuit to circuit, because the semiconductor integrated circuit is adapted to various kinds of circuit for general purpose use. The transmitter and receiver circuits therefore have to be used basically in a mismatched state. This makes it more difficult to transmit a high-speed data signal correctly.

Furthermore, when the mount substrate is partitioned along the alternate long and short dash line 1317-1317′ in FIG. 14, it is necessary to transmit a large volume of data at a high speed via a line routed by long wiring. This increases emission of an electromagnetic field from the line, and results in electromagnetic interference with other electronic devices or magnetic circuits. The amplitude level at the receiving end is specified for signal transmission via a signal line in the related. Hence, a sufficient quality may be ensured at the receiving end; however, the amplitude level of a signal cannot be lowered. In other words, it is difficult to take an EMI countermeasure, and as a result, restrictions in circuit design are imposed and the cost is increased. At the transmitting end, besides the load at the receiving end, a stray capacitance of the line has to be driven at the same time. Extra energy is therefore needed for signal transmission. In short, power consumption is increased as a result.

In addition, a transfer data rate per transmission channel is limited for the technique in the related art. It is therefore necessary to provide lines in parallel to transmit high-speed data. However, when the number of wires is increased as the speed of data transmission increases, a larger physical space is required for the wires. This naturally imposes stricter restrictions on the circuit design.

In particular, when wires pass through a movable portion, such as the hinge portion, in the clamshell structure, characteristic impedance varies with a manner in which the movable portion is bent. Impedance mismatch therefore occurs depending on the situations, and reflection or the like in the bending portion gives rise to signal deterioration. Hence, there is a problem that a rate of the data to be transmitted is limited and restrictions are imposed on the mounting method and locations of components.

Further, in order to meet the higher resolution and a higher speed of the display body element and the imaging sensor, several tens of signals have to be transmitted via the hinge portion. Moreover, when the wires pass through the hinge portion, wires on the substrate cannot be used, and a flexible substrate is connected via a connector. The flexible substrate and the connection via the connector have a defect that not only the cost is increased, but also the connection reliability is low.

### SUMMARY

An advantage of the invention is to provide low-cost, highly-reliable electronic device, signal transmission device, and radio communication terminal by removing defects and restrictions of the information transmission schemes in the related art by providing a high-speed transmission scheme for data having various problems and restrictions as those in the related art discussed above in signal transmission among circuits within an electronic device, such as a cellular phone, incorporating a display body and an imaging sensor.

According to a first aspect of the invention, an electronic device includes: a generator that generates transmission data in a form of a serial signal; an oscillator that generates a carrier wave; a modulator that modulates the carrier wave with the signal from the generator; a line transmission channel that transmits a signal modulated in the modulator; a demodulator that receives and demodulates the signal transmitted via the line transmission channel; a receiver that receives the transmission data according to a demodulated signal demodulated in the demodulator; and a common housing that accommodates at least the modulator and the demodulator.

When configured in this manner, the band of a signal transmitted via the line transmission channel can be increased using small-sized components and on lower power consumption due to operations of the modulator (modulator circuit) and the demodulator (demodulator circuit). It is thus possible to increase a volume of data that a single transmission channel can transmit. Hence, even when a quantity of transmission of signals transmitted within the housing is increased, signals can be transmitted within the housing using fewer line transmission channels. It is thus possible to reduce the number of signal lines provided within the housing. The electronic device can thus achieve a higher function and higher performance by reducing interference, such as emission noises, while achieving a reduction in size.

According to a second aspect of the invention, an electronic device includes: a generator that generates transmission data in a form of a serial signal; an oscillator that generates a carrier wave; a synchronizing signal generator that generates a synchronizing signal; a modulator that modulates the carrier wave with the signal from the generator; a synthesizer that synthesizes a modulated signal modulated in the modulator and the synchronizing signal from the synchronizing signal generator into a signal; a line transmission channel that transmits the signal synthesized in the synthesizer; a separator that receives and separates the signal transmitted via the line transmission channel into the modulated signal and the synchronizing signal; a demodulator that demodulates the modulated signal separated in the separator according to the synchronizing signal separated in the separator; a receiver that receives the transmission data according to a demodulated signal demodulated in the demodulator; and a common housing that accommodates at least the modulator and the demodulator.

When configured in this manner, the band of a signal transmitted via the line transmission channel can be increased using small-sized components and on lower power consumption due to operations of the modulator (modulator circuit) and the demodulator (demodulator circuit). It is thus possible to increase a volume of data that a single transmission channel can transmit. Hence, even when a quantity of transmission of signals transmitted within the housing is increased, signals can be transmitted within the housing using fewer line transmission channels; moreover, the synchronizing signal between the transmitting end and the receiving end can be superimposed on the same line. It is thus possible to reduce the number of signal lines provided within the housing. Also, the circuit configuration for demodulation at the receiving end can be simpler. In addition, interference, such as emission noises, can be reduced. The electronic device can thus achieve a higher function and higher performance while achieving a reduction in size.

According to a third aspect of the invention, an electronic device includes: a generator that generates transmission data in a form of a serial signal; an oscillator that generates a carrier wave; a modulator that modulates the carrier wave with the signal from the generator; a line transmission channel that transmits a signal modulated in the modulator; a demodulator that receives and demodulates the signal transmitted via the line transmission channel; a receiver that receives the transmission data according to a demodulated signal demodulated in the demodulator; and a common, secondary power supply that supplies power to at least the modulator and the demodulator.

The third aspect is advantageous in a case where data is transmitted between the circuits that are disposed in extremely close proximity to each other and use the same secondary power supply. When configured in this manner, even in a case where a quantity of transmission of signals to be transmitted is increased, the band of a signal transmitted via the line transmission channel can be increased using small-sized components due to operations of the modulator (modulator circuit) and the demodulator (demodulator circuit) and on lower power consumption without increasing the complexity of the power supply. It is thus possible to reduce the number of signal lines provided within the housing and a space needed to install the power supply. The electronic device can thus achieve a higher function and higher performance while achieving a reduction in size.

According to a fourth aspect of the invention, an electronic device includes: a generator that generates transmission data in a form of a serial signal; an oscillator that generates a carrier wave; a synchronizing signal generator that generates a synchronizing signal; a modulator that modulates the carrier wave with the signal from the generator; a synthesizer that synthesizes a modulated signal modulated in the modulator and the synchronizing signal from the synchronizing signal generator into a signal; a line transmission channel that transmits the signal synthesized in the synthesizer; a separator that receives and separates the signal transmitted via the line transmission channel into the modulated signal and the synchronizing signal; a demodulator that demodulates the modulated signal separated in the separator according to the synchronizing signal separated in the separator; a receiver that receives the transmission data according to a demodulated signal demodulated in the demodulator; and a common, secondary power supply that supplies power to at least the modulator and the demodulator.

The fourth aspect of the invention is advantageous in a case where data is transmitted between circuits that are disposed in extremely close proximity to each other and use the same secondary power supply. When configured in this manner, even in a case where a quantity of transmission of signals to be transmitted is increased, the band of a signal transmitted via the line transmission channel can be increased using small-sized components and on lower power consumption due to operations of the modulator (modulator circuit) and the demodulator (demodulator circuit) without increasing the complexity of the power supply; moreover, the synchronizing signal between the transmitting end and the receiving end can be superimposed on the same line. It is thus possible to reduce the number of signal lines provided within the housing and a space needed to install the power supply. In addition, the demodulator (demodulator circuit) can be simpler. The electronic device can thus achieve a higher function and higher performance while achieving a reduction in size.

According to a fifth aspect of the invention, an electronic device includes: a generator that generates display data in a form of a serial signal; an oscillator that generates a carrier wave; a modulator that modulates the carrier wave with the signal from the generator; a line transmission channel that transmits a signal modulated in the modulator; a demodulator that receives and demodulates the signal transmitted via the line transmission channel; and a display that displays the display data according to a demodulated signal demodulated in the demodulator.

When configured in this manner, by increasing the band of a signal to be transmitted by modulating the carrier wave with the signal, the fractional band (a ratio of the highest frequency and the lowest frequency in the frequency band, or a ratio of the frequency bandwidth and the central frequency) can be smaller and the frequency characteristic within the signal band can be uniform. It is therefore easy to design the line transmission channel and the matching circuit that terminates the line transmission channel, and the number of the line transmission channels can be reduced by serializing the signals. In addition, because the frequency to be handled can be increased, the circuit components needed for the matching can be reduced in size, which is advantageous in terms of mounting. Further, by increasing the band of the signal to be transmitted, it is possible to increase a volume of data that a single transmission channel can transmit. The number of line transmission channels can be therefore reduced. Hence, not only can the mounting of the device circuits be easier, but also the cost can be saved. Furthermore, because modulation and demodulation are adopted to transmit a signal, the need to transmit a digital signal in the baseband as in the related art can be eliminated. This in turn eliminates the need to maintain the signal level of a reception signal at the logic level. Power at the transmitting end can be therefore lowered. It is thus possible to reduce interference with the outside while achieving an advantage that power consumption of the device can be saved.

According to a sixth aspect of the invention, an electronic device includes: a generator that generates display data in a form of a serial signal; an oscillator that generates a carrier wave; a synchronizing signal generator that generates a synchronizing signal; a modulator that modulates the carrier wave with the signal from the generator; a synthesizer that synthesizes a modulated signal modulated in the modulator and the synchronizing signal from the synchronizing signal generator into a signal; a line transmission channel that transmits the signal synthesized in the synthesizer; a separator that receives and separates the signal transmitted via the line transmission channel into the modulated signal and the synchronizing signal; a demodulator that demodulates the modulated signal separated in the separator according to the synchronizing signal separated in the separator; and a display that displays the display data according to a demodulated signal demodulated in the demodulator.

When configured in this manner, by increasing the band of a signal to be transmitted by modulating the carrier wave with the signal, the fractional band (a ratio of the highest frequency and the lowest frequency in the frequency band, or a ratio of the frequency bandwidth and the central frequency) can be smaller and the frequency characteristic within the signal band can be uniform. It is therefore easy to design the line transmission channel, and the number of the line transmission channels can be reduced by serializing the signals. In addition, because the number of line transmission channels can be reduced, the mounting of the device circuits becomes easier and the cost can be saved. Further, because modulation and demodulation are adopted to transmit a signal, the need to transmit a digital signal in the baseband as in the related art can be eliminated. This in turn eliminates the need to maintain the signal level of a reception signal at the logic level. Power at the transmitting end can be therefore lowered. It is thus possible to reduce interference with the outside while achieving an advantage that power consumption of the device can be saved. Furthermore, because the synchronizing signal between the transmitting end and the receiving end is superimposed on the same line, when this synchronizing signal is used, demodulation at the receiving end can be achieved by a simple circuit.

According to a seventh aspect of the invention, an electronic device includes: an imaging sensor; an image signal transmitter that reads out an image signal from the imaging sensor and transmits the image signal in a form of a serial signal; an oscillator that generates a carrier wave; a modulator that modulates the carrier wave with the image signal; a line transmission channel that transmits a signal modulated in the modulator; and a demodulator that receives and demodulates the signal transmitted via the line transmission channel.

When configured in this manner, by increasing the band of a signal to be transmitted by modulating the carrier wave with the signal, the fractional band (a ratio of the highest frequency and the lowest frequency in the frequency band, or a ratio of the frequency bandwidth and the central frequency) can be smaller and the frequency characteristic within the signal band can be uniform. It is therefore easy to design the line transmission channel, and the number of the line transmission channels can be reduced by serializing the signals. In addition, because the number of line transmission channels can be reduced, the mounting of the device circuits can be easier and the cost can be saved. Further, because modulation and demodulation are adopted to transmit a signal, the need to transmit a digital signal in the baseband as in the related art can be eliminated. This in turn eliminates the need to maintain the signal level of a reception signal at the logic level. Power at the transmitting end can be therefore lowered. It is thus possible to reduce interference with the outside while achieving an advantage that power consumption of the device can be saved.

According to an eighth aspect of the invention, an electronic device includes: an imaging sensor; an image signal transmitter that reads out an image signal from the imaging sensor and transmits the image signal in a form of a serial signal; an oscillator that generates a carrier wave; a synchronizing signal generator that generates a synchronizing signal; a modulator that modulates the carrier wave with the image signal; a synthesizer that synthesizes a modulated signal modulated in the modulator with the synchronizing signal from the synchronizing signal generator into a signal; a line transmission channel that transmits the signal synthesized in the synthesizer; a separator that receives and separates the signal transmitted via the line transmission channel into the modulated signal and the synchronizing signal; and a demodulator that demodulates the modulated signal separated in the separator according to the synchronizing signal separated in the separator.

When configured in this manner, by increasing the band of a signal to be transmitted by modulating the carrier wave with the signal, the fractional band (a ratio of the highest frequency and the lowest frequency in the frequency band, or a ratio of the frequency bandwidth and the central frequency) can be smaller and the frequency characteristic within the signal band can be uniform. It is therefore easy to design the line transmission channel, and the number of line transmission channels can be reduced by serializing the signal. In addition, because the number of the line transmission channels can be reduced, the cost can be saved by making the mounting of the device circuits easier. Further, because modulation and demodulation are adopted to transmit a signal, the need to transmit a digital signal in the baseband as in the related art can be eliminated. This in turn eliminates the need to maintain the signal level of a reception signal at the logic level. Power at the transmitting end can be therefore lowered. It is thus possible to reduce interference with the outside while achieving an advantage that power consumption of the device can be saved. Furthermore, because the synchronizing signal between the transmitting end and the receiving end is superimposed on the same line, when this synchronizing signal is used, demodulation at the receiving end can be achieved by a simple circuit.

The modulator may perform modulation by multiplying the carrier wave by the serial signal.

When configured in this manner, modulation can be performed by merely multiplying the carrier wave by the serialized data signal. The configuration of the modulator circuit can be therefore simpler. In particular, when both of the signals are digital signals as in this case, an exclusive OR circuit can be used. Modulation can be thus achieved with an extremely simple circuit.

The modulator may modulate the carrier wave through QPSK modulation using the serial signal.

When configured in this manner, because QPSK modulation is adopted, it is sufficient to choose four carrier waves whose phases are shifted by 90° from each other using the bit pattern of the serial signal. Modulation can be therefore achieved with a simple digital circuit. It is also possible to reduce a symbol rate with the QPSK modulation, which can in turn relax the characteristic required for the transmission channel.

The synchronizing signal may be a horizontal synchronizing signal to maintain synchronization with a scanning line.

When configured in this manner, because the synchronizing signal is in sync with the horizontal synchronizing signal for image display or imaging, the boundary of the packets transmitted in series can be readily detected, which can in turn make the packet synchronization easier.

The synchronizing signal may be generated by dividing the carrier wave generated in the oscillator.

When configured in this manner, because the synchronizing signal is generated by dividing the carrier wave, the phases of the carrier wave and the synchronizing signals are locked. The demodulation operation at the receiving end is thus enabled in reference to this signal. The circuits used for synchronization acquisition or synchronization detection needed for demodulation can be markedly simpler. In addition, even when the frequency accuracy of the carrier wave is not high, because the synchronizing signal always follows the carrier wave, accuracy of the carrier wave oscillator (oscillator circuit) can be lowered. Hence, not only can the design and the manufacturing of the system be easier, but also the cost can be saved.

The demodulator may perform synchronization detection that regenerates and uses a frequency of the carrier wave in sync with the synchronizing signal.

When configured in this manner, the carrier wave is regenerated at the receiving end in sync with the synchronizing signal. The phases of the synchronizing signal and the carrier wave are therefore locked. This makes the synchronization detection easy, and highly reliable communications are enabled with simple circuits.

The oscillator may be formed of an oscillator circuit and a phase locked loop (PLL) that multiplies a periodical pulse train generated in the oscillator circuit.

When configured in this manner, because the carrier wave is brought in sync with the oscillation pulse train from the oscillation circuit by the PLL, the system can be readily designed and the circuit can be made simpler with ease.

The line transmission channel may include a switch to be able to switch transmission and reception directions.

When configured in this manner, the same transmission channel can be used by switching the transmission and reception directions of data to be transmitted. It is possible to construct, for example, an electronic device in which transmission directions of data to be transmitted are different, such as a cellular phone with a camera including both the display body and the imaging sensor, without increasing the transmission channels. This prevents an increase of the cost of the device. Moreover, the design and the packaging of the electronic device can be easier.

According to a ninth aspect of the invention, a signal transmission device includes: a transmitter that transmits transmission data in a form of a serial signal; an oscillator that generates a carrier wave; a synchronizing signal generator that generates a synchronizing signal; a modulator that modulates the carrier wave with the serial signal; a synthesizer that synthesizes a modulated signal modulated in the modulator and the synchronizing signal from the synchronizing signal generator into a signal; a line transmission channel that transmits the signal synthesized in the synthesizer; a separator that receives and separates the signal transmitted via the line transmission channel into the modulated signal and the synchronizing signal; and a demodulator that demodulates the modulated signal separated in the separator according to the synchronizing signal separated in the separator.

When configured in this manner, by moving the frequency band of data to be transmitted to a higher band through modulation in reducing the fractional band, it is possible to use a band in which the frequency characteristic of the line transmission channel is satisfactory. A transmission capacity per line transmission channel can be thus increased. The signal transmission device can be therefore achieved using fewer (in many cases, a single line transmission channel) line transmission channels. In addition, according to the transmission scheme of the invention, because a single line transmission channel is sufficient, the mounting is readily performed, and a countermeasure against interference with the outside and noises from the surroundings can be readily taken; moreover, restrictions in circuit design can be removed. In addition, it is possible to construct a highly-reliable system without increasing the cost.

According to a tenth aspect of the invention, a radio communication terminal includes: a first housing; a second housing; a connector that links the first housing to the second housing in such a manner that a positional relation between the first housing and the second housing is changeable; an outside radio communication antenna that is outfitted to one of the first housing and the second housing; an outside radio communication control portion that is mounted to the first housing and is chiefly responsible for control performed on an outside radio communication via the outside radio communication antenna; a display mounted to the second housing; a line transmission channel that passes through the connector and performs an internal communication between the first housing and the second housing; a first signal transmitter and receiver mounted to the first housing; a second signal transmitter and receiver mounted to the second housing; a first internal signal transmission controller that is mounted to the first housing and is responsible for switching between transmission and reception of the internal communication performed via the line transmission channel and control of the internal communication; and a second internal signal transmission controller that is mounted to the second housing and is responsible for switching between transmission and reception of the internal communication performed via the line transmission channel and control of the internal communication.

When configured in this manner, even in an electronic device of a complex clamshell structure having the display body and the imaging sensor, signal transmission between the two housings can be performed via a single transmission channel. It is thus possible to construct a highly-reliable system without increasing the cost. Even in a case where a volume of data transmitted between the housings is increased to meet the higher resolution of the display mounted to the radio communication terminal, data communications are enabled between the housings without causing a delay while suppressing an increase of the number of wires between the housings. As a result, even when the radio communication terminal adopts the clamshell structure, not only is it possible to prevent the structure of the connector from increasing the complexity, but it is also possible to prevent the mounting process from becoming complicated. It is thus possible to reduce the radio communication terminal in size and weight and increase the reliability while suppressing an increase of the cost. Moreover, the radio communication terminal can be provided with a larger screen and multiple functions without impairing the portability of the radio communication terminal.

As has been described, according to the invention, data transmission among the circuits within the electronic device can be achieved via fewer line transmission channels. Various problems arising from the high-speed data transmission and problems arising from the packaging in the related art can be therefore eliminated. It is thus possible to achieve a low-cost, highly-reliable electronic device that consumes less power.

### BRIEF DESCRIPTION OF THE DRAWINGS

The invention will be described with reference to the accompanying drawings, wherein like numbers reference like elements.

FIG. 1 is a block diagram showing a major portion in one embodiment of an electronic device of the invention.

FIG. 2 is a view showing an example of a separator circuit and a synthesizer circuit in the electronic device of the invention.

FIG. 3 is a block diagram showing a major portion in another embodiment of the electronic device of the invention.

FIG. 4 is a block diagram showing a major portion in still another embodiment of the electronic device of the invention.

FIGS. 5A through 5Q are time charts used to describe operations according to still another embodiment of the electronic device of the invention.

FIG. 6 is a block diagram showing a major portion in still another embodiment of the electronic device of the invention.

FIG. 7 is a block diagram showing a major portion in still another embodiment of the electronic device of the invention.

FIG. 8 is a block diagram showing a major portion in still another embodiment of the electronic device of the invention.

FIGS. 9A through 9K are time charts detailing operations in a sixth embodiment of the invention.

FIGS. 10A through 10C are block diagrams and a waveform chart showing an example of oscillator circuits and multiplier circuits in the embodiments of the invention.

FIG. 11 is a perspective view showing a state where a clamshell cellular phone, to which a signal transmission control method of the invention is applied, is opened.

FIG. 12 is a perspective view showing a state where the clamshell cellular phone, to which the signal transmission control method of the invention is applied, is closed.

FIG. 13 is a view showing the outward appearance of a rotary-type cellular phone to which the signal transmission control method of the invention is applied.

FIG. 14 is a block diagram used to describe an electronic device provided with a liquid crystal display body in the related art.

FIGS. 15A through 15K are time charts used to describe operations of the electronic device provided with the liquid crystal display body in the related art.

### DESCRIPTION OF EXEMPLARY EMBODIMENTS

Hereinafter, embodiments of the invention will be described with reference to the drawings.

### First Embodiment

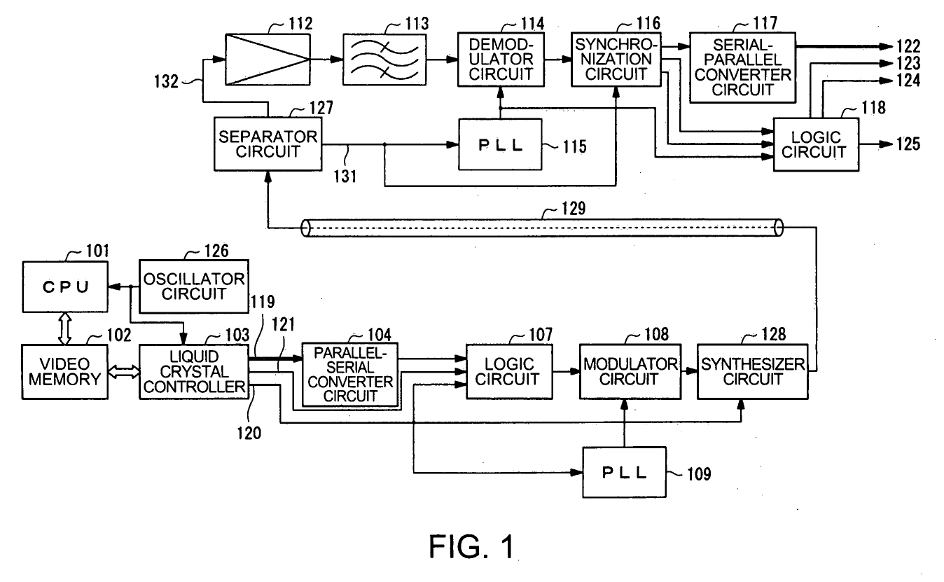

FIG. 1 is a block diagram showing the detailed configuration of an information transmission scheme of the invention and one embodiment of an electronic device using the scheme.

Referring to FIG. 1, a CPU 101 generates display data to be displayed through computations or the like, and records the display data in a video memory 102. A liquid crystal controller 103 reads out display data 119 to be displayed on a display body from the video memory 102 according to a specific sequence, and outputs the display data 119 together with a vertical synchronizing signal 121 and a horizontal synchronizing signal 120. Because the display data signal 119 is normally read out from the video memory 102 for each word in the form of data in parallel pixel by pixel, it is subjected to parallel-serial conversion in a parallel-serial converter circuit 104 and transmitted further to a logic circuit 107. The logic circuit 107 receives a signal outputted from the parallel-serial converter circuit 104 as well as the horizontal synchronizing signal 120 and the vertical synchronizing signal 121 outputted from the liquid crystal controller 103, and generates packets. The logic circuit 107 also appends a preamble to adjust timing for synchronous detection to each packet. Operations of the preamble will be described in detail in a sixth embodiment below. The packet is modulated in a modulator circuit 108 with a carrier frequency generated by multiplying the horizontal synchronizing signal 120 in a PLL 109, and transmitted further via a line transmission channel 129 by way of a synthesizer circuit 128. For example, a coaxial cable can be used as the line transmission channel 129. The synthesizer circuit 128 synthesizes an output from the modulator circuit 108 and the horizontal synchronizing signal 120 outputted from the liquid crystal controller 103 into a composite signal and outputs the composite signal so that these two signals are transmitted via the single line transmission channel 129. A concrete example of the synthesizer circuit 128 will be described below.

An oscillator circuit 126 is an oscillator circuit that generates a clock pulse train needed for the operations of the CPU 101 and the liquid crystal controller 103. The liquid crystal controller 103 generates various timings as well as the horizontal synchronizing signal 120 and the vertical synchronizing signal 121 by dividing the clock pulse generated in the oscillator circuit 126. The PLL 109 generates a carrier wave by multiplying the horizontal synchronizing signal 120. In short, the carrier wave is in sync with the horizontal synchronizing signal 120.

The line transmission channel 129 transmits signals of two kinds, that is, an output from the modulator circuit 108 and the horizontal synchronizing signal 120 outputted from the liquid crystal controller 103, which are synthesized in the synthesizer circuit 128. Herein, the modulator circuit 108 operates to lower the frequency frictional band of a signal transmitted via the line transmission line 129 to allow the use of a flat portion in the characteristic of the line transmission channel 129. The line transmission channel 129 is thus able to transmit all the data that needs to be transmitted in serial forms. Because only one line transmission channel 129 is provided, a line with a satisfactory characteristic can be used with a slight increase of the cost.

A composite signal of an output from the modulator circuit 108 and the horizontal synchronizing signal 120 outputted from the liquid crystal controller 103 is transmitted via the line transmission channel 129 and separated into a modulated wave signal 132 and a horizontal synchronizing signal 131 in a separator circuit 127. The modulated wave signal 132 separated in the separator circuit 127 is amplified in a preamplifier 112, after which components in an unwanted band are removed by a bandpass filter 113, and the resultant signal is inputted into a demodulator circuit 114. The bandpass filter 113 may not be necessary unless the line transmission channel 129 has too poor noise resistance. However, in order to reduce power at the transmitting end to the lowest possible level, it is preferable to remove out of band noises as much as possible using the bandpass filter 113.

The horizontal synchronizing signal 131 separated in the separator circuit 127 is outputted to both a PLL 115 and a synchronization circuit 116. The frequency of the horizontal synchronizing signal 131 separated in the separator circuit 127 is multiplied in the PLL 115 to restore the carrier frequency. The horizontal synchronizing signal 131 is then supplied to the demodulator circuit 114 and the reception signal is demodulated in the demodulator circuit 114. The PLL 115 operates to restore the frequency and the phase completely the same as those of the carrier wave used for the modulation at the transmitting end. This makes synchronous detection quite easy. The synchronization circuit 116 detects the boundary between reception signal packets using the horizontal synchronizing signal 131 separated in the separator circuit 127, and performs packet synchronization. A serial-parallel converter circuit 117 extracts a portion of display data 122 from the demodulated reception packets, and generates the display data 122 by applying serial-parallel conversion pixel by pixel.

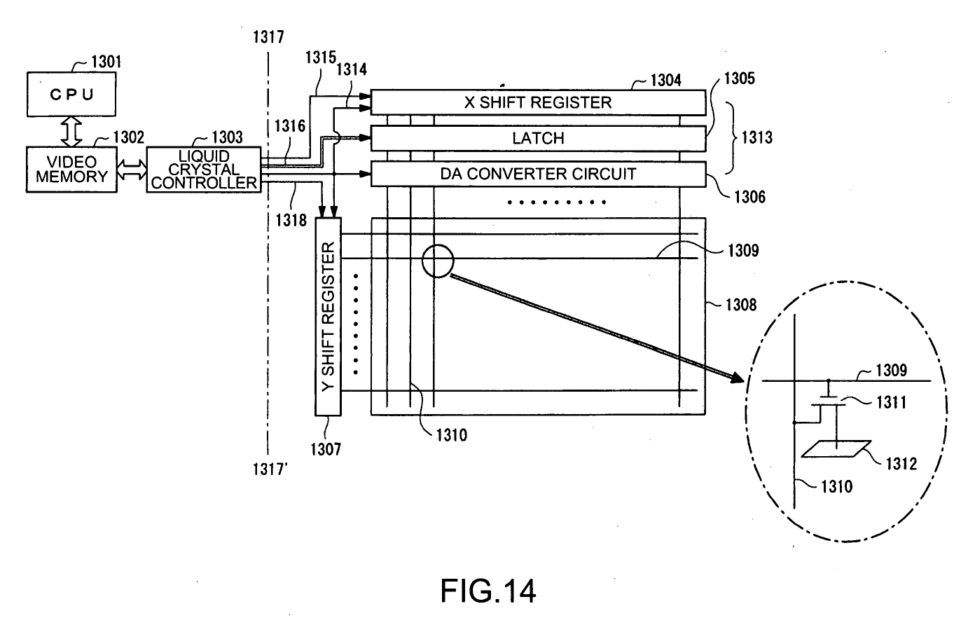

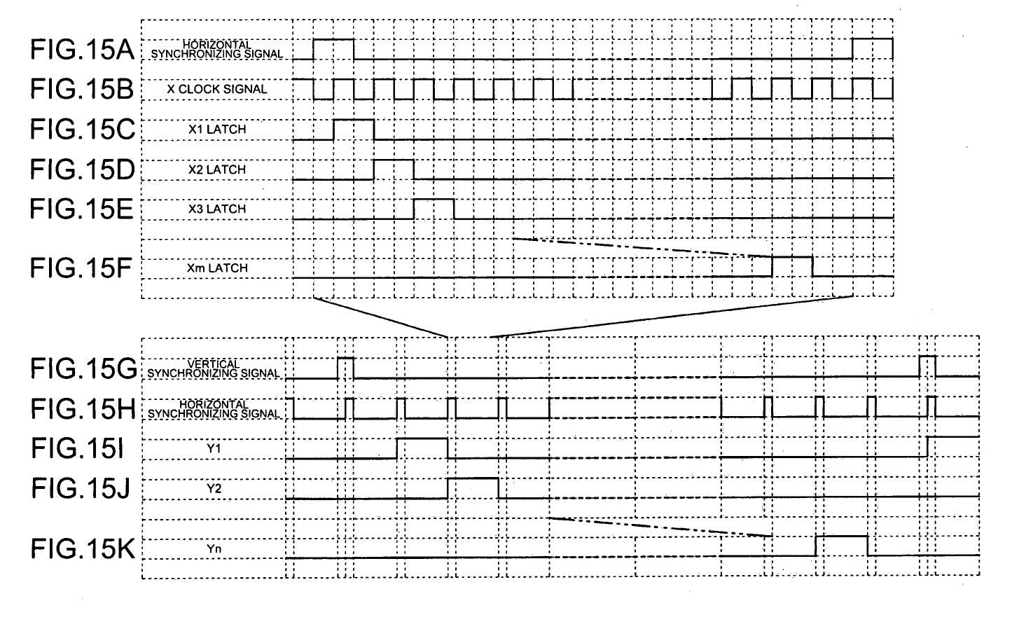

A logic circuit 118 generates a horizontal synchronizing signal 123, a vertical synchronizing signal 124, and a transfer clock 125 for the X driver at the timing of the display data 122 within the packets from the demodulated packets, and outputs these signals to the drivers of the liquid crystal display body as signals equivalent to the drivers of the liquid crystal display body, that is, the horizontal synchronizing signal 1314, the vertical synchronizing signal 1318, and the X clock signal 1315 of FIG. 14 for the display data 122 to be displayed.

As the frequency generated by the PLL 109, a frequency that neither causes interference with nor receives interference from an original purpose of the electronic device using electric waves, such as a radio receiver and a cellular phone, is selected. Selection of the frequency is crucial because even in a case where the line transmission channel 129 has a good transmission characteristic and a signal being transmitted is hardly leaked, the frequency directly gives influences to the receiver sensitivity in an electronic device, such as a cellular phone, that receives a faint signal from a remote place. When a frequency at or higher than 2 GHz at which the receiver remains unsusceptible is selected, an occupied band is about 200 MHz when data of 100 Mbps is transmitted, and a fractional band is 1/10 or less. In comparison with a transmission channel that requires a band of several octaves from the DC to 200 MHz or higher in the related art, it is easy to make the frequency characteristic within the band flat. Also, it is easy to design the matching circuit that terminates the line transmission channel 129. It is thus possible to ensure communications with a good performance (although the matching circuit is omitted in FIG. 1, no description is necessary as to the need to insert matching circuits at the both ends of the transmission channel 129 to minimize the waveform deformation by suppressing reflection at the both ends of the transmission line 129 and to transmit transmission energy efficiently). Further, it is easy to reduce the device in size because the components forming these circuits handle high frequencies, which can in turn save the mounting space. In addition, because the matching becomes easy, efficiency for signal energy can be enhanced due to satisfactory matching. This is advantageous to save power consumption.

Normally, in radio communications, carrier frequencies handled by the modulator circuit 108 at the transmitting end and the demodulator circuit 114 at the receiving end have to coincide with each other. On the other hand, the frequency of the carrier wave oscillator circuit between the transmission end and the reception end requires a high degree of accuracy. A difference between these frequencies appears directly as deterioration of the communication quality. According to the configuration of the invention as above, however, the modulator circuit 108 and the demodulator circuit 114 obtain carrier waves through multiplication using the PLL's 109 and 115 having the same characteristic in reference to the same reference signal, that is, by using the horizontal synchronizing signal 120 that is in sync with the clock pulse generated in the same oscillator circuit 126. Hence, there is no difference between the carrier frequencies at the transmitting end and the receiving end. The accuracy of the oscillator circuit 126 does not raise any problem, and this is advantageous to save the cost. The PLL 115 is not necessarily provided, and an output from the PLL 109 may be directly transmitted to the demodulator circuit 114. However, when a carrier wave and a modulated wave are transmitted via a single transmission channel, these waves cannot be readily separated, which results in the use of two transmission channels. This is not quite reasonable. It is more feasible to transmit a reference signal at a low frequency like the horizontal synchronizing signal 120, and restore the carrier wave at the frequency as high as that of the output of the PLL 109 by multiplying the reference signal in the PLL 115 as in the configuration described above.

The preamplifier 112 enables a reception of a quite faint signal. In addition, it is possible to furnish the preamplifier 112 with a function of an equalizer or the like to correct the characteristic of the line transmission channel 129. This makes it possible to maintain the communication quality with far smaller emission power than unwanted emission power generated from the line transmission channel 129 in comparison with the transmission scheme in the related art in which the reception signal level has to be maintained at a specific value. A fundamental EMI countermeasure can be thus taken. In addition, power consumption can be reduced in comparison with the transmission scheme in the related art in which a storage capacity of the line transmission channel 129 have to be driven at the logic level.

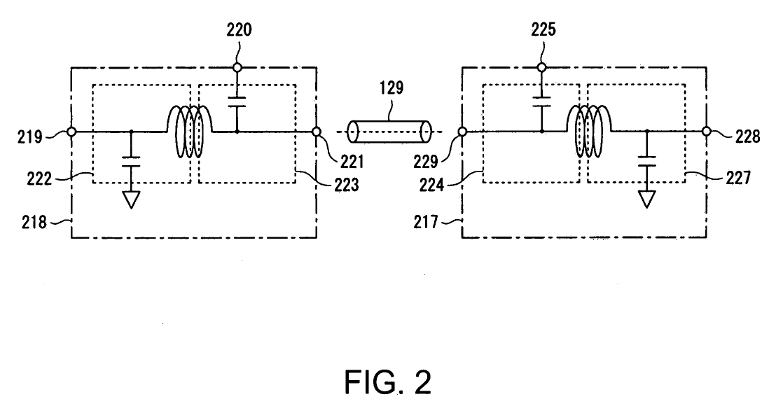

FIG. 2 is a view showing more in detail an example of the synthesizer circuit 128 and the separator circuit 127 used in this embodiment of the invention. The interior of the synthesizer circuit 128 of FIG. 1 is shown in detail inside of a block indicated by an alternate long and short dash line 217. The horizontal synchronizing signal 120 is inputted to a terminal 228, and a terminal 229 is connected to the line transmission channel 129. A modulated signal from the modulator circuit 108 is inputted into the transmission channel 129 from a terminal 225 via a high-pass filter 224. Meanwhile, the horizontal synchronizing signal 120 is inputted into the transmission channel 129 via a low-pass filter 227. A modulated signal from the modulator circuit 108 will not leak to the terminal 228 side because of the presence of the low-pass filter 227. The horizontal synchronizing signal 120 will not leak to the terminal 225 side, either, because of the presence of the high-pass filter 224. The modulated signal and the horizontal synchronizing signal 120 are therefore synthesized into a composite signal, which is transmitted to the line transmission channel 129 correctly. Both of the signals synthesized over the line transmission channel 129 are separated in the separator circuit 127.

The interior of the separator circuit 127 is shown in detail inside of a block indicated by an alternate long and short dash line 218. A terminal 221 is connected to the line transmission channel 129. A display data signal 119 that is modulated in the modulator circuit 108 and comes into the terminal 221 is separated in a high-pass filter 223, and transmitted to the preamplifier 112 from a terminal 220. A low-pass filter 222 allows only the horizontal synchronizing signal 120 made of low frequency components to be transmitted from a terminal 219 to prevent leakage of the display data signal 119. The horizontal synchronizing signal 120 alone is therefore transmitted correctly to the PLL 115 inside the receiving block via the terminal 219. As is shown in the drawing, the circuits forming the synthesizer circuit 128 and the separator circuit 127 are the same. Hence, a signal can be also transmitted from the block 218 to the block 217. In this case, the separating and synthesizing functions are inverted. Also, the transmission directions of the horizontal synchronizing signal 120 and the display data signal 119 are not necessarily the same. For example, it may be configured in such manner that the display data signal 119 is transmitted from the block 217 side, while the horizontal synchronizing signal 120 is transmitted from the block 218 side.

When configured in this manner, it is possible to transmit a high-speed, large volume of display data to be transmitted to the display body via a single line transmission channel. In comparison with the technique in the related art where a large number of parallel line transmission channels are necessary, it is easy to take a countermeasure against noises and interference from the outside or interference with the outside. Moreover, it is possible to eliminate various problems arising from the line transmission, such as an increase of power consumption, restrictions in wiring location, noises, an EMI problem, and deterioration of reliability, that have become noticeable as the display body increases in size.

### Second Embodiment

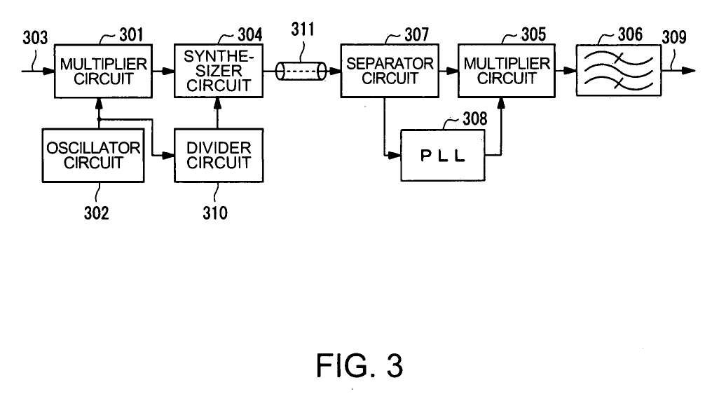

FIG. 3 is a block diagram showing a major portion in another embodiment of the electronic device of the invention. It also shows in detail a portion equivalent to a portion from the modulator circuit 108 to the demodulator circuit 114 of the first embodiment.

Referring to FIG. 3, an oscillator circuit 302 is an oscillator circuit that generates a carrier wave, and generates a rectangular pulse train at the carrier frequency. The oscillator circuit 302 is equivalent to the PLL 109 of the first embodiment. A multiplier circuit 301 multiplies a carrier wave generated in the oscillator circuit 302 by input data 303. A synthesizer circuit 304 synthesizes a synchronizing signal generated by dividing an output from the oscillator circuit 302 by means of a divider circuit 310 and the multiplication result from the multiplier circuit 301, and transmits a composite signal to a transmission channel 311. In the first embodiment, the synchronizing signal is generated by dividing a pulse train generated in the oscillator circuit 126 by means of the liquid crystal controller 103, and the carrier wave is generated by multiplying the synchronizing signal thus generated in the PLL 109. However, when the configuration as the second embodiment is adopted, the carrier wave from the oscillator circuit 302 and the synchronizing signal generated in the divider circuit 310 are in sync with each other. The device therefore operates in the same manner. Because both the input data 303 and the output from the oscillator circuit 302 are digital signals, the multiplier circuit 301 can be an exclusive OR circuit. By giving an analog value “1” for the logic “0”, and an analog value “−1” for the logic “1”, then the inputs and the outputs of the exclusive OR circuit act just like a multiplier circuit. In addition, because communications are made via the line transmission channel 311, higher harmonic interference given to other equipment circuits and the like is suppressed to a low level from the start. The processing to remove higher harmonic components from an output of the modulator circuit using a filter or the like as in the phase modulation used in radio communications is therefore unnecessary.

A signal transmitted via the line transmission channel 311 is separated into a synchronizing signal and a reception data signal in a separator circuit 307. A PLL 308 generates a carrier wave by multiplying the frequency of the synchronizing signal by a factor of the dividing ratio of the divider circuit 310 in reference to the synchronizing signal. The reception data signal is then inputted into a multiplier circuit 305, and multiplied by the carrier wave regenerated in the PLL 308. After higher harmonic components are removed by a low-pass filter 306, the reception data signal is demodulated as a demodulated signal 309. The low-pass filter 306 removes high frequency components (fine pulse components generated due to a slight phase-shift difference between the reception data signal separated in the separator circuit 307 and the waveform of a regenerated clock of the PLL 308) from an output of the multiplier circuit 305, and outputs the resultant signal as the demodulated signal 309.

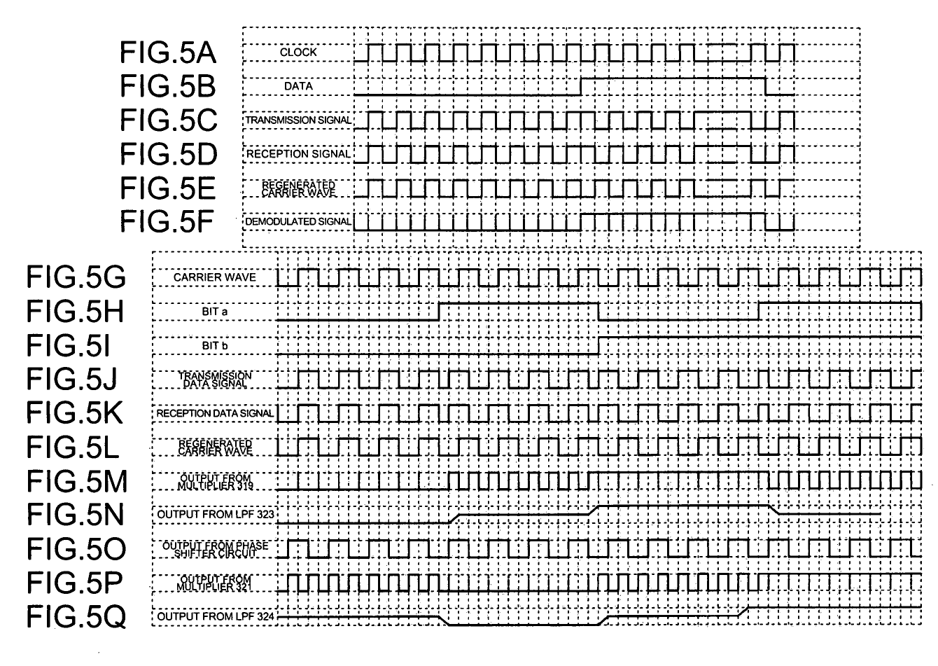

FIGS. 5A through 5C are time charts of the modulator circuit 108 of FIG. 1 described above. More specifically, FIG. 5A shows a carrier wave (clock) generated in the oscillator circuit 302. FIG. 5B shows transmission data, and FIG. 5C shows a transmission signal to be outputted. When the time charts of these drawings are assumed to be a digital circuit, then the modulator circuit 108 is an exclusive OR circuit. When the time charts are assumed to be an analog value that takes “±1”, then the modulator circuit 108 is a multiplier circuit.

FIGS. 5D through 5F show time charts of the demodulator circuit 114 in the first embodiment. More specifically, FIG. 5D shows a reception signal. FIG. 5E shows a carrier wave pulse train regenerated in the PLL 308, and FIG. 5F shows an output from the multiplier circuit 305. The low-pass filter 306 removes higher harmonic components generated due to a slight phase difference between the reception signal and the output of the PLL 308 from the signal outputted from the multiplier circuit 305, and restores a demodulated signal 309. Referring to FIG. 5D, although the reception signal is illustrated in the form of a pulse train at the logic level, even when sufficient amplitude cannot be ensured as in this case, the device is still able to operate in the same manner by using an analog multiplier circuit instead of an exclusive OR circuit, as the multiplier circuit 305.

As can be understood from these drawings, when the carrier wave (FIG. 5A) and the regenerated carrier wave (FIG. 5E) are at different frequencies or their phases are displaced, demodulation cannot take place properly. In communications in the related art, a difference is reduced to the minimum by providing high-accuracy oscillator circuits to the transmitting end and the receiving end separately. According to the configuration of this embodiment, however, because the regenerated clock at the receiving end is based on the output from the oscillator circuit 302 at the transmitting end, a regenerated clock at the same frequency as that at the transmitting end can be always ensured at the receiving end. As a result, no difference in terms of the stability of the oscillation frequency and accuracy of the frequency is produced. It is therefore possible to construct a circuit having an extremely high stability by using the inexpensive oscillator circuit 302.

Because a communication quality with a satisfactory good S/N ratio can be ensured in this embodiment of the invention, a signal can be amplified to the extent that it can be deemed as a digital value (an amplifier circuit is omitted in FIG. 3). In this case, the amplified signal level is raised as high as the logical value level. However, the load driven by the logical value is not a long distance accompanied with a large stray capacitance, such as a transmission line from the CPU to the display body, but it is quite a short and low load within the same semiconductor chip. Power consumption is not therefore increased. Even when the reception signal is at an analog level that is not amplified to the logical value level, because an output from the PLL 3.08 is of a rectangular shape (takes a value “±1”), multiplications can be performed using a simple switch circuit. In other words, as will be described below, a double balanced multiplier circuit, and an inverting amplifier circuit and a normal amplifier having equal absolute values as the degrees of amplification and polarities opposite to each other are prepared. Then, the multiplication can be performed by choosing an output from the inverting amplifier circuit using the switch when the logical level of an output from the PLL 308 is “1”, and by choosing an output from the normal amplifier circuit when the logical level of an output from the PLL 308 is “0”. A circuit configured in this manner may be used as the multiplication circuit 305.

When configured as described above, the modulator circuit 108 can be achieved by an exclusive OR circuit, and the demodulator circuit 114 can be achieved by a single exclusive OR circuit or an analog multiplier circuit and a low-pass filter with ease.

### Third Embodiment

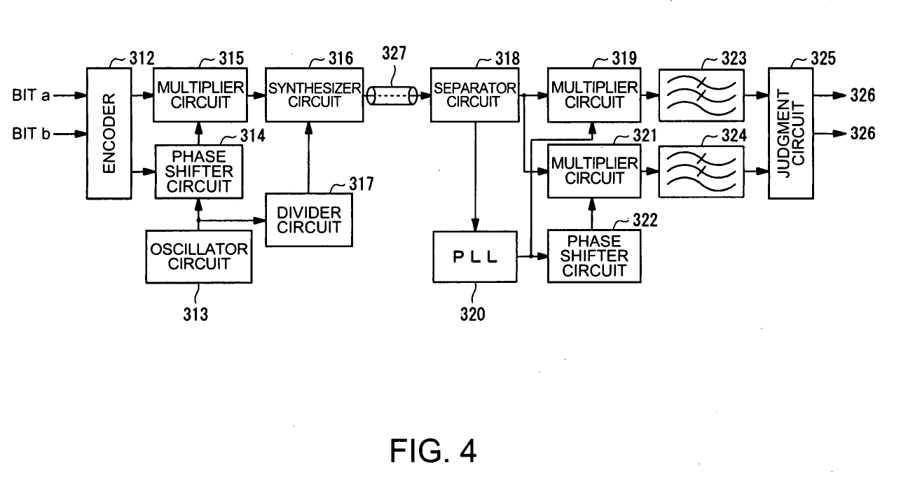

FIG. 4 is a block diagram showing a major portion in still another embodiment of the electronic device of the invention. It also shows in detail a portion equivalent to a portion from the modulator circuit 108 to the demodulator circuit 114 of the first embodiment.

The second embodiment has been described using simplified BPSK modulation as an example. However, in this embodiment, an example based on QPSK modulation will be described to indicate a case where more general phase modulation is used. An oscillator circuit 313 is a rectangular pulse oscillator circuit equivalent to the PLL 109 of the first embodiment. According to the QPSK modulation, a transmission signal is encoded by allocating two bits (that is, a data bit a and a data bit b) for each symbol and then transmitted. In other words, the transmission signal is transmitted after it is modulated by encoding a quantity of phase shift, for example, as is set forth in Table 1 below, with respect to the reference clock. An encoder 312 controls a phase shifter circuit 314 and a multiplier circuit 315 to achieve a phase shift as is set forth in Table 1 below using a bit pattern of the data bit a and the data bit b.

Table 1

FIGS. 5G through 5J are time charts showing operations of the respective portions in the modulator circuit shown in FIG. 4. The encoder 312 encodes the bit a (FIG. 5H) and the bit b (FIG. 5I) of the transmission data. The encoder 312 controls the phase shifter circuit 314 whether it shifts the phase of the carrier wave (FIG. 5G) oscillated from the oscillator circuit 313 by 90°, and controls further the multiplier circuit 315 whether it inverts the carrier wave (shifts the phase by 180°). The encoder 312 thus finally outputs the QPSK-modulated transmission data signal (FIG. 5J). The transmission data signal is synthesized in a synthesizer circuit 316 with the synchronizing signal generated by dividing an output from the oscillator circuit 313 by means of a divider circuit 317, and the resultant composite signal is outputted to a transmission channel 327.

The signal transmitted via the transmission channel 327 is separated into the synchronizing signal and the reception data signal in a separator circuit 318. A PLL 320 generates a regenerated carrier wave (FIG. 5L) by multiplying the frequency of the synchronizing signal by a factor of the dividing ratio of the divider circuit 317 in reference to the synchronizing signal separated in the separator circuit 318.

The regenerated carrier wave outputted from the PLL 320 is multiplied in a first multiplier circuit 319 by a reception data signal (FIG. 5K) separated in the separator circuit 318, and the resultant signal is transmitted to a first low-pass filter 323 for the higher harmonic components to be removed, after which the resultant signal is transmitted to a judgment circuit 325. The reception data signal separated in the separator circuit 318 is also multiplied in a second multiplier circuit 321 by a pulse train (FIG. 50), which is obtained by shifting the phase of the regenerated carrier wave generated in the PLL 320 by 90° by means of a 90°-phase shifter circuit 322. After the higher harmonic components are removed from the resultant signal by a second low-pass filter 324, the resultant signal is transmitted to the judgment circuit 325. The judgment circuit 325 finds the transmission data from the outputs (FIGS. 5N and 5Q) of the first and second low-pass filters 323 and 324, and outputs a demodulated signal 326 by demodulating the reception data signal.

According to the configuration described above, a signal to be transmitted is modulated with the carrier wave, so that the band of a signal transmitted to the transmission channel 327 can be increased. It is thus possible to accelerate data transmission without having to increase a band occupied by the signal transmitted to the transmission channel 327. In addition, because the modulator circuit can be achieved by a simple digital circuit, it can be incorporated into the semiconductor chip. An increase of the cost and power consumption is therefore negligible. Because the regenerated carrier wave needed at the receiving end is generated on the basis of the oscillator circuit 313, which is the same as the one at the transmitting end, no difference in terms of accuracy of the clock frequency is produced between the transmitting end and the receiving end. Moreover, stable data transmission is enabled even when the inexpensive oscillator circuit 313 is used.

When the frequency of the oscillator circuit 313 is forcedly changed at the transmitting end, the receiving end always follows the changed frequency. It is thus possible to choose a frequency forcedly at the transmitting end in response to the communication channel with the outside of the device such that neither causes interference with the communication channel nor receives interference from the communication channel with the outside of the device in an electronic device, for example, a radio communication device (this also applies to the first and second embodiments). In short, it makes extremely easy to take a countermeasure against interference and jamming with communications, which is the original purpose of the electronic device, such as a communication device.

### Fourth Embodiment

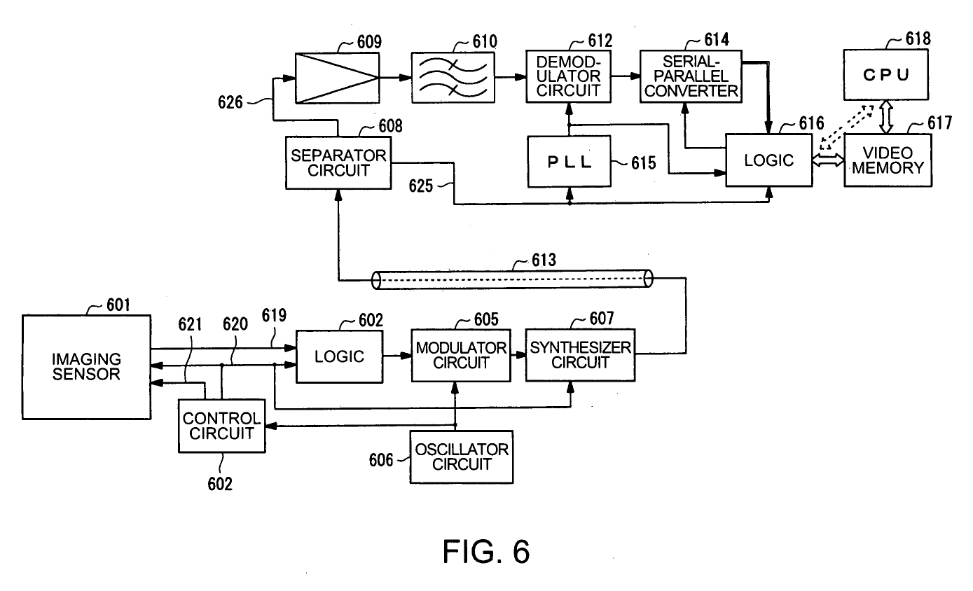

FIG. 6 is a block diagram showing a major portion in still another embodiment of the electronic device of the invention. It shows an example where an information transmission scheme of the invention is applied to an electronic device using an imaging sensor.

Referring to FIG. 6, an imaging sensor 601 is activated by a horizontal synchronizing signal 620 and a vertical synchronizing signal 621 generated in a control circuit 602, and outputs picked up image data 619 to a logic circuit 603. Upon receipt the image data 619 outputted from the imaging sensor 601 and the horizontal synchronizing signal 620 generated in the control circuit 602, the logic circuit 603 constructs transmission packets. The packets are inputted into a modulator circuit 605, and used to modulate a carrier wave generated in an oscillator circuit 606. The packets are then synthesized with the horizontal synchronizing signal 620 in a synthesizer circuit 607, and the resultant composite signal is transmitted to the receiving end via a line transmission channel 613.

The signal transmitted to the line transmission channel 613 is received at the receiving end, and separated in a separator circuit 608 into a horizontal synchronizing signal 625 and a modulated wave 626 modulated in the modulator circuit 605. The modulated wave 626 thus separated is amplified in a preamplifier 609. After an unwanted out of band signal is removed by a bandpass filter 610, the amplified signal is inputted into a demodulator circuit 612. A PLL 615 generates a carrier wave by multiplying the horizontal synchronizing signal 625 to the frequency of the carrier wave, and inputs the carrier wave into the demodulator circuit 612. The demodulator circuit 612 also extracts transmission packets by using synchronizing timing needed for demodulation known from the horizontal synchronizing signal 625. A serial-parallel converter circuit 614 extracts an image data portion from the demodulated reception packets, and generates pixel data by applying serial-parallel conversion to the image data portion pixel by pixel.

A logic circuit 616 generates a memory address for the pixel data thus demodulated to be written into a video memory 617, and writes the image data into the video memory 617 at the address thus generated either directly or via a CPU 618. The CPU 618 accesses the video memory 617 and uses the image data for various applications.

Normally, the CPU 618 performs the control, such as activation of the imaging sensor 601. However, it is possible to transmit information about the activation from the CPU 618 to the control circuit 602 in the imaging sensor 601 as a synchronizing signal. In other words, this alternative configuration is possible, because, as has been described in the first embodiment, the separator circuit 608 and the synthesizer circuit 607 can be achieved using the same configuration and transmission directions can be changed. A more detailed method will be described in a fifth embodiment below.

When configured in this manner, it is possible to eliminate various problems arising from line transmission, such as an increase of power consumption, restrictions in wiring location, an EMI problem, and deterioration of the reliability, which have become noticeable as the imaging sensor 601 is increased in size. In addition, because the synchronizing timing needed for demodulation is transmitted to the receiving end via the line transmission channel 613 that is also used for transmission of the image data signal, the need for synchronization acquisition can be eliminated at the receiving end. The circuit can be therefore simplified significantly. Moreover, because the carrier wave generated from the same oscillation source is used as the reference at both the transmitting end and the receiving end, the degree of accuracy of the frequency required for the oscillator circuit 606 can be lowered markedly. This is significantly advantageous to save the cost and increase the feasibility.

### Fifth Embodiment

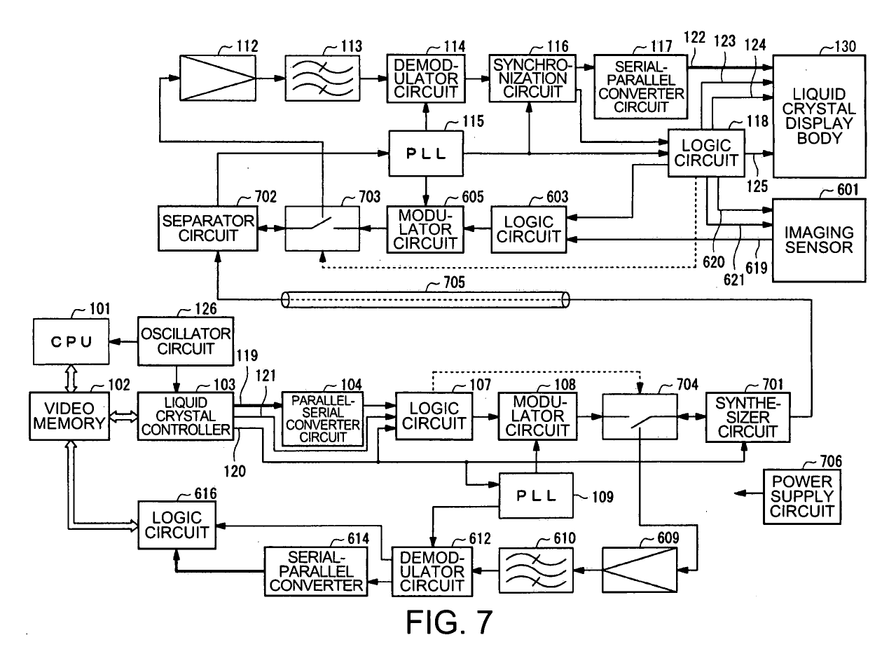

FIG. 7 is a block diagram showing a major portion in still another embodiment of the invention. This embodiment is an example where an imaging sensor 601 is also included near a liquid crystal display body 126, and the configurations of the first embodiment and the fourth embodiment are combined on a back-to-back basis. In other words, it is configured in such a manner that the block diagrams of FIG. 1 and FIG. 6 are located so that the CPU 101 of FIG. 1 is used also as the CPU 618 of FIG. 6. Like components are labeled with like reference numerals with respect to FIG. 1 and FIG. 6. Because these components are identical with their counterparts described in the first and fourth embodiments above, the description of these components is omitted herein.

Referring to FIG. 7, a modulator circuit 108 modulates a display data signal 119 stored in a video memory 102 to be converted into a signal at a high frequency yet in a low fractional band. The modulated signal is then synthesized with the horizontal synchronizing signal 120 in a synthesizer circuit 701 and the resultant composite signal is transmitted to a transmission channel 705. A switch 704 present between the modulator circuit 108 and the synthesizer circuit 701 is a switch circuit that switches transmission directions of a signal to be transmitted, that is, either the display data signal 119 to be displayed on the liquid crystal display body 126 or imaging data picked up by the imaging sensor 601. After the synchronizing signal 120 is separated from the composite signal in a separator circuit 702, the display data signal 119 transmitted via the transmission channel 705 is transmitted to a preamplifier 112, demodulated in a demodulator circuit 114, and outputted to the liquid crystal display body 126.

The imaging sensor 601 is disposed near the liquid crystal display body 126. Communication packets are constructed from the imaging data obtained by the imaging sensor 601 in a logic circuit 603, and the packets are transmitted to a switch 703 after they are modulated in a modulator circuit 605. The switches 703 and 704 are configured to switch depending on whether the data to be transmitted is the imaging data or the display data. More specifically, when the data to be transmitted is the display data, the switch 704 is switched to the modulator circuit 108, while the switch 703 is switched to the preamplifier 112. On the other hand, when the data to be transmitted is the imaging data, the switch 704 is switched to a preamplifier 609, while the switch 703 is switched to the modulator circuit 605.

When the display and the imaging are performed simultaneously, operations are enabled by performing switching repetitively in a short time such that enables the display and the imaging to be performed substantially simultaneously, for example, frame by frame or for every horizontal scanning line.

The imaging data having passed through the switch 703 is transmitted to the synthesizer circuit 701 by way of the separator circuit 702 and the transmission channel 705. In this case, the horizontal synchronizing signal 120 is transmitted to the transmission channel 705 from the synthesizer circuit 701, whereas the imaging data is transmitted to the transmission channel 705 in a direction opposite to the direction of the horizontal synchronizing signal 120, that is, from the separator circuit 702. As has been described in the first embodiment above, the separator circuit 702 and the synthesizer circuit 701 are of the same circuit topology, and are therefore able to operate as functions opposite to each other as in this case. The imaging signal transmitted to the transmission channel 705 is separated from the horizontal synchronizing signal 120 in the synthesizer circuit 701, and stored in the video memory 102 after it is demodulated in a demodulator circuit 612. The CPU 101 performs the control, such as the writing of the imaging data into the video memory 102 at a specific address for the imaging data to be displayed on the liquid crystal display body 126. A power supply circuit 706 is a secondary power supply circuit and supplies power to the respective blocks within the circuit by stepping down a voltage to stabilize power from an AC power supply. The power supply circuit 706 may be furnished with a function of charging an internal battery or stabilizing a voltage from the battery. In this system, because the signal transmitting end and the receiving end are present in extremely close proximity to each other, power can be supplied to the modulator circuits 108 and 605 at the transmitting end and the demodulator circuits 114 and 612 at the receiving end from the single power supply circuit 706. It is thus possible to increase a band of a signal to be transmitted via the transmission channel 705 without having to prepare power supplies separately for the modulator circuit 108 and 605 at the transmitting end and for the demodulator circuits 114 and 612 at the receiving end. A space needed for the installment of the power supplies can be therefore saved. It is thus possible to increase a volume of data that can be transmitted via the transmission channel 705 while achieving a reduction of the electronic device in size.

It is understood from comparison between FIG. 6 and FIG. 7 that the modulator circuit 605 obtains the carrier wave from the PLL 115 in FIG. 7, whereas the modulator circuit 605 obtains the carrier wave from the oscillator circuit 606 in FIG. 6. Conversely, the demodulator circuit 612 obtains the carrier wave from the PLL 109 at the receiving end in FIG. 7. That is to say, the locations of the PLL 115 and the oscillator circuit 126 are inverted between the transmitting end and the receiving end depending on whether the display data is transmitted or the imaging data is transmitted. Such a configuration is possible because the PLL 115 has been previously synchronized with the oscillator circuit 126 by the transmission-reception system for display. In other words, the only available method is to maintain the synchronization with a transmitted signal at the receiving end in a one-way communication; however, in a two-way communication, it is possible to maintain synchronization at the transmitting end in response to the timing at the receiving end as in this embodiment. Packets are therefore generated at the transmitting end of the imaging data at the timing of the horizontal synchronizing signal 120 transmitted from the receiving end of the imaging data, and the packets are transmitted by adjusting the phase to the phase of the carrier wave. When the PLL 115 has been previously synchronized with the oscillator circuit 126 by the transmission-reception system for display in this manner, synchronization can be maintained at the transmitting end of the imaging data. A circuit used for maintaining synchronization at the receiving end of the imaging data can be therefore omitted.

As has been described, by performing two-way communications within the same housing, data can be transmitted to the liquid crystal display body 126 and a signal can be transmitted from the imaging sensor 601 disposed near the liquid crystal display body 126. The circuit can be therefore simpler by sharing the common portion.

### Sixth Embodiment

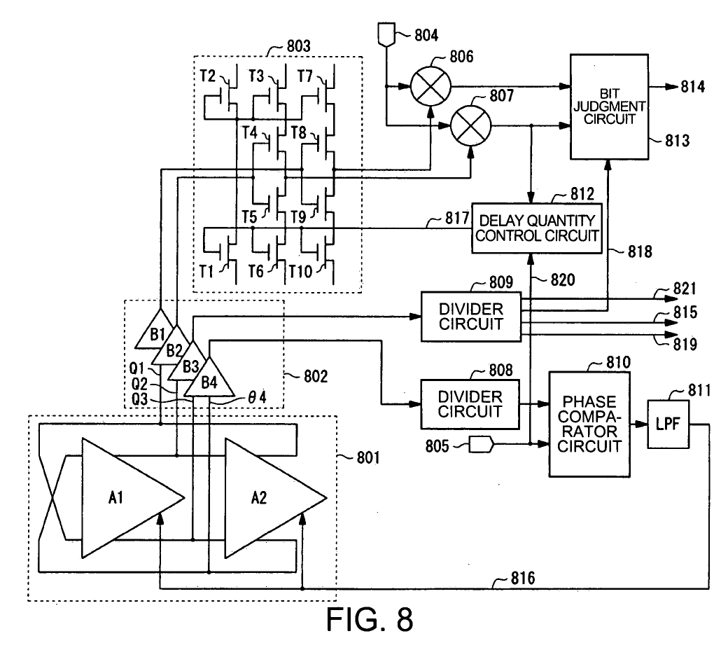

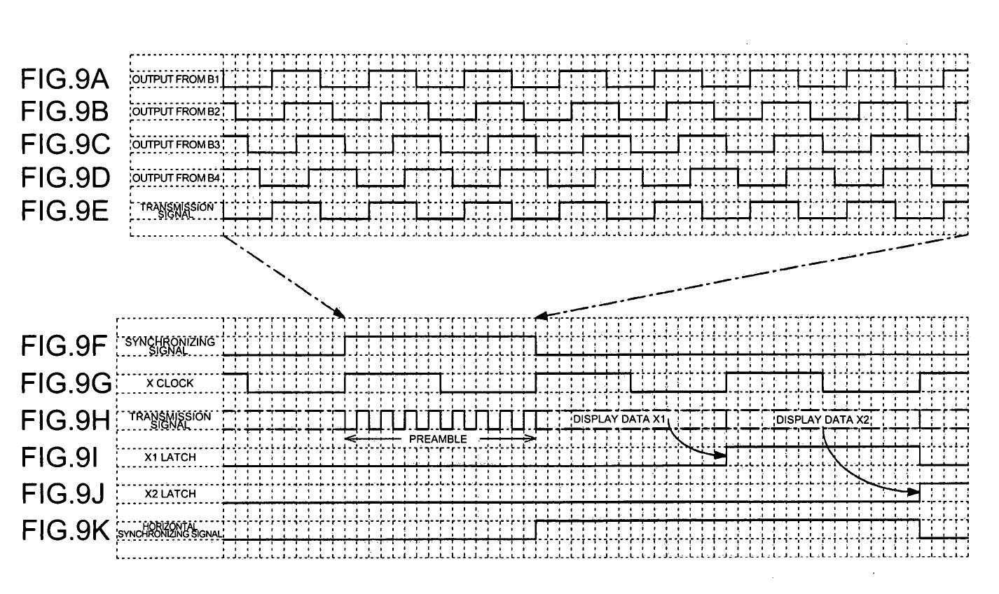

FIG. 8 is a view showing in detail a major portion in still another embodiment of the invention, in particular, a PLL and a demodulator portion at the receiving end. It also shows the more concrete internal structures of the PLL's 109, 115, 308, 320, and 615, and the oscillator circuits 302, 313, and 606 in the first, second, third, fourth, and fifth embodiments. FIGS. 9A through 9K are time charts showing the operations briefly.

Referring to FIG. 8, a voltage control oscillator circuit 801, a divider circuit 808, a phase comparator circuit 810, and a low-pass filter (LPF) 811 together form the PLL, and a synchronizing signal 805 from the transmitting end is inputted into the terminal. As is shown in FIG. 9F, the synchronizing signal 805 simultaneously indicates the position at which the preamble is present (described below, FIG. 9H). It is easy to output such a signal from the liquid crystal controller 103. The voltage control circuit 801 comprises cascade connected two differential amplifier circuits A1 and A2. As is shown in FIG. 8, it is possible to generate four phases of oscillation signals Q1 through Q4 each having a phase shifted by 90° by inverting outputs from the differential amplifier circuits A1 and A2 and feeding back the inverted outputs to the inputs. The oscillation frequencies of the oscillation signals Q1 through Q4 can be controlled by changing the bias of the differential amplifier circuits A1 and A2. When the ring-type oscillator circuit as described above is formed on the semiconductor substrate, the upper limit is determined by a stray capacitance of the semiconductor element, and a signal can be oscillated at the highest frequency that the semiconductor integrated circuit can oscillate. Conversely, once the oscillation frequency is determined, it is possible to lower power consumption to the minimum to oscillate at the determined frequency. Because a duty ratio becomes out of balance due to the load for each output from the voltage control circuit 801, the outputs are subjected to buffer amplification in a buffer circuit 802 to become satisfactory symmetric loads. The four oscillation signals Q1 through Q4 of the voltage control circuit 801 are thus extracted (FIGS. 9A, 9B, 9C, and 9D).

The QPSK modulation as described in the third embodiment above is performed at the transmitting end using the four phases of the oscillation signals Q1 through Q4 generated in the voltage control circuit 801. Any one of the phases of buffer circuits B1, B2, B3, and B4 is selected by the transmission bit pattern and transmitted.

At the receiving end, after a quantity of delay for outputs from the buffer circuits B1 and B2 having a phase difference of 90° is adjusted in a delay circuit 803, the outputs are multiplied by a reception signal 804 in multiplier circuits 806 and 807. Outputs from the multiplier circuits 806 and 807 include information of transmission data, and a demodulated output 814 is obtained after higher harmonic components are removed and bit judgment is performed in a bit judgment circuit 813.

The output from the buffer circuit B4 is divided by the divider circuit 808, and the phase comparator circuit 810 compares the divided signal with the synchronizing signal 805. After the output passes through the low-pass filter 811, the output is fed back to the differential amplification circuits A1 and A2 in the voltage control oscillator circuit 801. The oscillation frequency of the voltage control oscillator circuit 801 is adjusted in such a manner that a phase difference between the output of the divider circuit 808 and the synchronizing signal 805 is constantly 0 (nil). The oscillation frequency of the voltage control oscillator circuit 801 is thus locked to the frequency of the synchronizing signal 805 multiplied by a factor of the dividing ratio of the divider circuit 808. Because the synchronizing signal 805 and the transmission packets have the same cycle, the packet synchronization can be maintained between the transmitting end and the receiving end. In addition, it is possible to maintain the synchronization for the frequency of the carrier wave.

As is shown in FIG. 1, the timings of the horizontal synchronizing signal and the vertical synchronizing signal and the read timing of the display data by the liquid crystal controller are obtained by dividing a clock oscillated from the oscillator circuit 126 at the transmitting end by the liquid crystal controller 103. Hence, at the receiving end, the various timing and the clocks for the head of the packet from the transmitting end, the bit boundary in the display data, an X clock signal used to drive the drivers of the liquid crystal display body can be readily obtained by dividing the oscillation signals Q1 through Q4 from the voltage control oscillator circuit 801 that multiplies the synchronizing signal 805. The divider circuit 809 generates a horizontal synchronizing signal 821 (FIG. 9K), a vertical synchronizing signal 819, and an X clock 815 by dividing an output from the buffer circuit B3. It also detects the boundary of the bits, and provides the timing for bit judgment by transmitting a bit boundary signal 818 to the bit judgment circuit 813.

For example, the synchronizing signal and the data signal transmitted via the same transmission channel 129 of FIG. 1 have slight phase displacement when they pass through the synthesizer circuit 128 and the separator circuit 127 due to a difference of the frequencies between the synchronizing signal and the data signal. Hence, as has been described, phase displacement is present also in the carrier wave regenerated at the receiving end by the PLL 115. Such phase displacement can be removed in the manner as follows.

That is, as is shown in FIGS. 9A through 9K, a fixed bit pattern is set at the specific position within one packet as a preamble, and transmitted as a transmission signal (FIG. 9H). The synchronizing signal 805 (FIG. 9F) can be said as a signal indicating an interval in which the preamble is present. FIG. 9E indicates a transmission signal within the preamble, and transmits data such that becomes in-phase with a signal outputted from the buffer circuit B1 as the bit pattern of the preamble. FIGS. 9F through 9K show the FIGS. 9A through 9E on a reduced time scale. The preamble is formed by inserting fixed bits of a predetermined number at the specific position in one communication packet (for example, one horizontal synchronizing interval). The position of the preamble can be known at the receiving end from the synchronizing signal 805 (FIG. 9F) being transmitted. Also, as has been described, the horizontal synchronizing signal 821 can be readily generated by counting the oscillation signals Q1 through Q4 from the voltage control oscillator circuit 801.

A delay quantity control circuit 812 receives the synchronizing signal 805 and controls a quantity of delay of the delay circuit 803, so that an output of the multiplier circuit 807 is maintained at the specific value during the preamble period. Because the preamble is to transmit the previously determined bit pattern, once the period of the preamble is known at the receiving end, it is possible to maintain the synchronization of the phases of the carrier wave between the transmitting end and the receiving end by matching the phase of the waveform of the reception signal 804 to the phases of the oscillation signals Q1 through Q4 oscillated from the voltage control oscillator circuit 801 during this period. The delay quantity control circuit 812 adjusts a quantity of delay of the delay circuit 803 to be the specific quantity during the preamble period until the following preamble period. The specific quantity referred to herein means that an output reaches the maximum when the phase of the carrier wave multiplied in the multiplier circuit 807 is a signal in-phase with the preamble, the output becomes 0 (nil) in the presence of a phase difference of 90°, and the output reaches the minimum in the case of the reversed phase.

In the example of FIG. 8, a signal of the preamble is in-phase with an output of the buffer circuit B1. However, because the phase of the carrier wave multiplied in the multiplier circuit 807 is inverted in the delay circuit 803, it shifts by 90° from the phase of the buffer circuit. B1, that is, the phase of the preamble. The delay quantity control circuit 812 therefore has to control the delay circuit 803 so that the output of the multiplier circuit 807 becomes 0 (nil). When a delay in phase of the preamble is larger than 90° from the carrier wave multiplied in the multiplier circuit 807, the output from the multiplier circuit 807 takes a negative value; otherwise, the output takes a positive value. Hence, when a delay in phase of the preamble is larger than 90°, a quantity of delay in the delay circuit 803 is increased, and a voltage of an output 817 from the delay quantity control circuit 812 is dropped to lessen the phase difference from the preamble; otherwise, the voltage is increased. As a consequence, a phase difference is adjusted by controlling the ON resistors of transistors T1, T6, and T10. The delay quantity control circuit 812 can be therefore a mere amplifier circuit having a large amplification degree. It goes without saying that a filter for removing higher harmonic components from the output of the amplification circuit 807 needs to be disposed at the preceding stage and the circuit function of maintaining a voltage value in periods other than the preamble period is necessary. However, these components are omitted in FIG. 8 for ease of description.

Inside the delay circuit 803, transistors T3, T6, T7, and T10 are inserted at the sources of the inverters comprising the transistors T4 and T5 and the transistors T8 and T9, so that delay times of the inverters are controlled by controlling currents flowing in the respective inverters. The transistors T1 and T2 are current mirrors, and therefore have advantages in improving the symmetric property of a P-channel transistor and an N-channel transistor that together form the inverter.

In addition, different from an output from the buffer circuit B2, an output from the buffer circuit B1 is not included in the loop. However, by mounting the transistors T4, T5, T3, and T6, and the transistors T8, T9, T7, and T10 on the same semiconductor substrate in extremely close proximity to each other to achieve a satisfactorily symmetric property, and by driving these transistors on the same control voltage 817, a quantity of delay equal to that of an output from the buffer circuit B1 can be obtained. Hence, by including any one of the oscillation signals Q1, Q2, Q3, and Q4 of the voltage control oscillator circuit 801 into the loop, it is possible to correct quantities of delay in the phases of the other oscillation signals among the oscillation signals Q1, Q2, Q3, and Q4.

The vertical synchronizing signal 819 can be detected more easily by adopting a method, by which a bit pattern different from the normal one is given to the preamble identifying as being the vertical synchronizing signal, or an information bit identifying as being the vertical synchronization signal is inserted into one horizontal scanning interval at a specific position as a data signal, and the data signal is detected at the receiving end.

Even when the synchronizing signal and the data signal causes phase displacement, a carrier wave for demodulation whose phase and frequency are completely in sync with those of the reception signal can be regenerated using the method described above. Moreover, any of these circuits can be integrated on the semiconductor integrated circuit, and operated on the minimum power consumption. It is thus possible to provide an inexpensive, highly-reliable circuit having extremely high feasibility.

### Seventh Embodiment

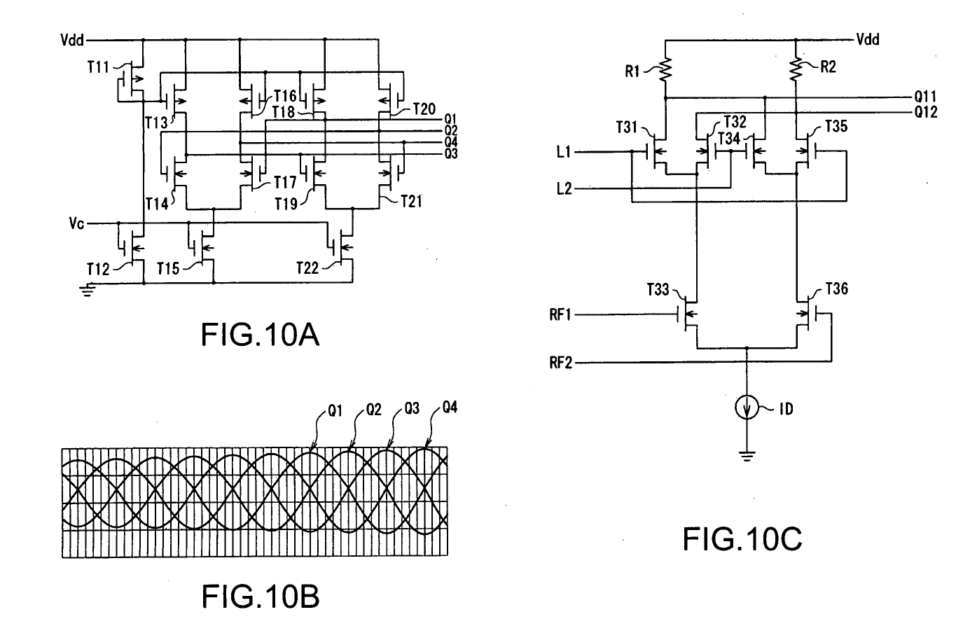

FIGS. 10A through 10C show a detailed example of a major portion in still another embodiment of the electronic device of the invention. It shows an example of the oscillator circuits and the multiplier circuits used in the first through fifth embodiments above. FIG. 10A shows a 4-phase oscillator circuit suitable for a CMOS integrated circuit. FIG. 10B is a waveform chart of the oscillator circuit.

Referring to FIG. 10A, the oscillator circuit is provided with transistors T11 through T22, and the differential amplifier circuit A1 of FIG. 8 comprises the transistors T13 through T17, while the differential amplifier circuit A2 of FIG. 8 comprises the transistors T18 through T22. By cascade connecting these differential amplifier circuits A1 and A2 to invert outputs from the differential amplifier circuits A1 and A2, and by feeding back the inverted outputs to the inputs, it is possible to extract the respective oscillation signals Q1, Q2, Q3, and Q4 of four phases from the drains of the transistors T19, T21, T14, and T17, respectively. Also, a current flowing into the differential pair can be controlled with a voltage given to the terminal Vc. Hence, a voltage control oscillator circuit capable of changing the oscillation frequency can be constructed or the PLL of the embodiments above can be constructed as well.

FIG. 10C shows an example of a differential multiplier circuit that can be used in the first through fifth embodiments above, and it is particularly suitable for a CMOS integrated circuit.

Referring to FIG. 10C, the sources of transistors T31 and T32 are connected to a constant current source ID via a transistor T33, while the sources of transistors T34 and T35 are connected to the constant current source ID via a transistor T36. In addition, the drains of the transistors T31 and T34 are connected to power supply potential vdd via a resistor R1, while the drains of the transistors T32 and T35 are connected to the power supply potential Vdd via a resistor R2.

Differential signals L1 and L2 of the oscillator circuit that can have relatively large amplitude are inputted, respectively, to the gates of the transistor T31 and T35 and the gates of the transistors T32 and T34, and (differential) reception signals RF1 and RF2, which are faint analog signals, are inputted into the gates of the transistors T33 and T36. Then, multiplication results of the both can be obtained from the drains of the transistors T31 and T34 and the drains of the transistors T32 and T35 as differential signals Q11 and Q12.

As has been described in the second embodiment above, when the inputs to the both multiplier circuits 301 and 305 of FIG. 3 take digital values, a mere exclusive OR circuit can be used. However, the multiplier circuit 305 used for demodulation at the receiving device end is often unable to amplify the level of the reception signal to the digital logic level. Hence, the multiplication is often a multiplication of a faint analog signal by a carrier wave from the local oscillator circuit. This embodiment provides a multiplier circuit suitable for the optimum CMOS integrated circuit in such a case, and it can be used as a frequency converter circuit as well.

All of these circuits can be integrated on the semiconductor substrate as CMOS integrated circuits; moreover, they can operate on low power consumption. When these circuits are used, large-scale integration is enabled together with other functional blocks. It is thus possible to achieve a remarkable saving of the cost and a highly-reliable device.

### Eighth Embodiment

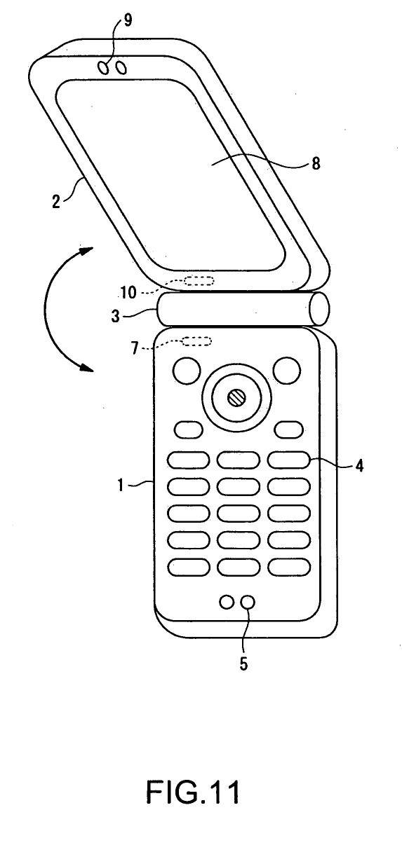

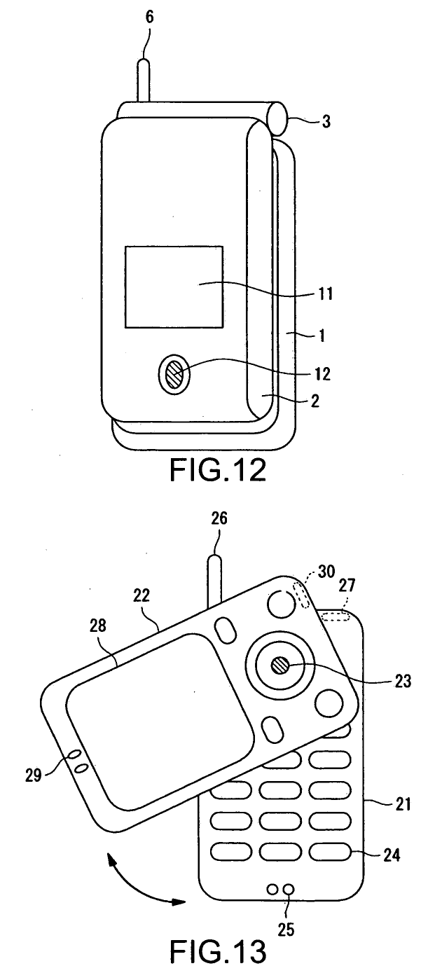

FIG. 11 is a perspective view showing a state where a clamshell cellular phone, to which a signal transmission control method of the invention is applied, is opened. FIG. 12 is a perspective view showing a state where the clamshell cellular phone, to which the signal transmission control method of the invention is applied, is closed.

Referring to FIG. 11 and FIG. 12, operation buttons 4 are provided on the surface of a first housing 1. A microphone 5 is provided at the lower end of the first housing 1, while an outside radio communication antenna 6 is provided at the upper end of the first housing 1. In addition, a display body 8 is provided to the surface of a second housing 2, while a speaker 9 is provided at the upper end of the second housing 2. Moreover, a display body 11 and an imaging sensor 12 are provided on the back surface of the second housing 2. For example, a liquid crystal display panel, an organic EL panel, or a plasma display panel can be used as the display bodies 8 and 11. Also, a CCD or a CMOS sensor can be used as the imaging sensor 12. Further, for the first housing 1 and the second housing 2, a line performing internal signal transmission between the first housing 1 and the second housing 2 is connected to a separator (or synthesizer) circuit 10 from a synthesizer (or separator) circuit 7 by passing through the interior of a hinge 3.

The first housing 1 and the second housing 2 are linked to each other via the hinge 3. By rotating the second housing 2 about the hinge 3 as the supporting point, the second housing 2 can be folded onto the first housing 1. By closing the second housing 2 onto the first housing 1, the operation buttons 4 can be protected by the second housing 2. It is thus possible to prevent the operation buttons 4 from being operated erroneously while the user is carrying around the cellular phone. By opening the second housing 2 from the first housing 1, the user is able to operate the operation buttons 4 while watching the display body 8, make a call using the speaker 9 and the microphone 5, or pick up an image by manipulating the operation buttons 4.

When the clamshell structure is used, the display body 8 can be placed across almost the entire surface of the second housing 2. It is thus possible to increase the display body 8 in size without impairing the portability of the cellular phone, which can in turn enhance the visibility.

In addition, by providing circuits 7 and 10 serving as either the synthesizer circuit or the separator circuit, respectively, to the first housing 1 and the second housing 2, data transmission between the first housing 1 and the second housing 2 is enabled using via a single transmission channel penetrating through the hinge 3. For example, image data or sound data taken into the first housing 1 via the outside radio communication antenna 6 can be transmitted to the second housing 2 via this transmission channel for an image to be displayed on the display body 8 or a sound to be outputted from the speaker 9. In addition, image data picked up by the imaging sensor 12 can be transmitted from the second housing 2 to the first housing 1 for the image data to be transmitted to the outside via the outside radio communication antenna 6.

As a result, data transmission between the first housing 1 and the second housing 2 is enabled via a single transmission channel. This eliminates the need to pass a multi-pin flexible printed circuit board through the hinge 3. Hence, not only is it possible to prevent the structure of the hinge 3 from increasing its complexity, but it is also possible to prevent the mounting process from being complicated. Hence, an increase of the cost can be suppressed while the cellular phone can be reduced in size and thickness and achieve a higher reliability. At the same time, the cellular phone can be provided with a larger screen and multiple functions without impairing the portability of the cellular phone.

The outside radio communication antenna 6 is attached to the first housing 1; however, it may be attached to the second housing 2. In this case, because the outside radio communication antenna 6 is not shielded by the second housing 2 during use, more efficient communications can be expected. In this case, power is supplied to the outside radio communication antenna 6 from the communication control portion of the cellular phone incorporated into first housing 1 via a coaxial cable or the like.

### Ninth Embodiment

FIG. 13 is a perspective view showing the outward appearance of a rotary-type cellular phone to which the signal transmission control method of the invention is applied.

Referring to FIG. 13, operation buttons 24 are provided on the surface of the first housing 21. A microphone 25 is provided at the lower end of the first housing 21, and an outside radio communication antenna 26 is provided at the upper end of the first housing 21. A display body 28 is provided to the surface of a second housing 22, while a speaker 29 is provided at the upper end of the second housing 22. In addition, circuits 27 and 30 that serve as either a synthesizer circuit or a separator circuit to perform internal signal transmission between the first housing 21 and the second housing 22 are provided to the first housing 21 and the second housing 22, respectively.

The first housing 21 and the second housing 22 are linked to each other via a hinge 23. By rotating the second housing 22 horizontally about the hinge 23 used as the supporting point, it is possible to place the second housing 22 over the first housing 21, or displace the second housing 22 from the first housing 21. By carrying around the cellular phone by placing the second housing 22 over the first housing 21, the operation buttons 24 can be protected by the second housing 22. It is thus possible to prevent the operation buttons 24 from being manipulated erroneously while the user is carrying out the cellular phone. Also, by displacing the second housing 22 from the first housing 21 by rotating the second housing 22 horizontally, the user is able to manipulate the operation buttons 24 while watching the display body 28 or make a call by using the speaker 29 and the microphone 25.

By providing the circuits 27 and 30 serving as either the synthesizer circuit or the separator circuit, respectively, to the first housing 21 and the second housing 22, data transmission between the first housing 21 and the second housing 22 is enabled through internal signal transmission via a single transmission channel. For example, image data or sound data taken into the first housing 21 via the outside radio communication antenna 26 is transmitted to the second housing 22 through the internal signal transmission using the circuits 27 and 30 serving as either the synthesizer circuit or the separator circuit for an image to be displayed on the display body 28 or a sound to be outputted from the speaker 29.

The need to pass a multi-pin flexible printed circuit board through the hinge 23 can be therefore eliminated. Hence, not only is it possible to prevent the structure of the hinge 23 from increasing its complexity, but it is also possible to prevent the mounting process from being complicated. Hence, an increase of the cost can be suppressed while the cellular phone can be reduced in size and thickness and achieve a higher reliability. At the same time, the cellular phone can be provided with a larger screen and multiple functions without impairing the portability of the cellular phone.

As has been described, according to this embodiment, high-speed data transmission that has been difficult to achieve by the technique in the related art can be achieved via a single transmission channel. Various problems arising from acceleration of speed, such as EMI, power consumption, a packaging space and reliability, restrictions in device design, and reliability of communication data, can be solved. Moreover, all of the circuits used to achieve the resolution can be integrated on a semiconductor integrated circuit as CMOS integrated circuits. The cost can be thus saved markedly in comparison with packaging components in the related art, such as connectors to connect a number of transmission channels on the flexible substrate, and the feasibility is extremely high.

The invention is to obtain a satisfactory communication characteristic by using a band having a flat characteristic by modulating a data stream to be transmitted in reducing the fractional band by increasing the frequency further. Because the frequency is high, it is easy to reduce the components used in size. Also, because only one transmission channel is used, it is easy to take a countermeasure, such as a shield, so that interference with the outside can be readily reduced. In addition, it is easy to take countermeasures even under the circumstances where a transmitter that transmits extremely strong electronic waves is incorporated into the same housing, such as a cellular phone.

The invention is applicable not only to a cellular phone, but also to a video camera, a PDA (Personal Digital Assistance), a notebook-sized personal computer, etc.

The entire disclosure of Japanese Patent Application No. 2004-353663, filed Dec. 7, 2004 is expressly incorporated by reference herein.

What is claimed is:

1. An electronic device, comprising:
a generator that generates transmission data in a form of a serial signal;
an oscillator that generates a carrier wave;
a modulator that modulates the carrier wave with the signal from the generator;
a line transmission channel that transmits a signal modulated in the modulator;
a demodulator that receives and demodulates the signal transmitted via the line transmission channel;
a receiver that receives the transmission data according to a demodulated signal demodulated in the demodulator; and
a common housing that accommodates at least the modulator and the demodulator.

2. An electronic device, comprising:
a generator that generates transmission data in a form of a serial signal;
an oscillator that generates a carrier wave;
a synchronizing signal generator that generates a synchronizing signal;
a modulator that modulates the carrier wave with the signal from the generator;
a synthesizer that synthesizes a modulated signal modulated in the modulator and the synchronizing signal from the synchronizing signal generator into a signal;
a line transmission channel that transmits the signal synthesized in the synthesizer;
a separator that receives and separates the signal transmitted via the line transmission channel into the modulated signal and the synchronizing signal;
a demodulator that demodulates the modulated signal separated in the separator according to the synchronizing signal separated in the separator;
a receiver that receives the transmission data according to a demodulated signal demodulated in the demodulator; and
a common housing that accommodates at least the modulator and the demodulator.

3. The electronic device according to claim 1, wherein:
the modulator performs modulation by multiplying the carrier wave by the serial signal.

4. The electronic device according to claim 1, wherein:
the modulator modulates the carrier wave through QPSK modulation using the serial signal.

5. The electronic device according to claim 2, wherein:
the synchronizing signal is a horizontal synchronizing signal to maintain synchronization with a scanning line.

6. The electronic device according to claim 2, wherein:
the synchronizing signal is generated by dividing the carrier wave generated in the oscillator.

7. The electronic device according to claim 2, wherein:
the demodulator performs synchronization detection that regenerates and uses a frequency of the carrier wave in sync with the synchronizing signal.

8. The electronic device according to claim 1, wherein:
the oscillator is formed of an oscillator circuit and a phase locked loop (PLL) that multiplies a periodical pulse train generated in the oscillator circuit.

9. The electronic device according to claim 1, wherein:
the line transmission channel includes a switch, and is thereby able to switch transmission and reception directions.

10. A radio communication terminal, comprising:
a first housing;
a second housing;
a connector that links the first housing to the second housing in such a manner that a positional relation between the first housing and the second housing is changeable;
an outside radio communication antenna that is outfitted to one of the first housing and the second housing;
an outside radio communication control portion that is mounted to the first housing and is chiefly responsible for control performed on an outside radio communication via the outside radio communication antenna;
a display mounted to the second housing;
a line transmission channel that passes through the connector and performs an internal communication between the first housing and the second housing;
a first signal transmitter and receiver mounted to the first housing;
a second signal transmitter and receiver mounted to the second housing;
a first internal signal transmission controller that is mounted to the first housing and is responsible for switching between transmission and reception of the internal communication performed via the line transmission channel and control of the internal communication; and
a second internal signal transmission controller that is mounted to the second housing and is responsible for switching between transmission and reception of the internal communication performed via the line transmission channel and control of the internal communication.
